(19) United States
(12) Patent Application Publication
(10) Pub. No.: US 2021/0168411 A1
(43) Pub. Date: Jun. 3, 2021

(54) STORAGE MEDIUM, VIDEO IMAGE GENERATION METHOD, AND VIDEO IMAGE GENERATION SYSTEM

(71) Applicant: FUJITSU LIMITED, Kawasaki-shi (JP)

(72) Inventors: Shinichi AKIYAMA, Kawasaki (JP); Kiyoshi KAWANO, Kawasaki (JP); Shinichirou MIYAJIMA, Oonojyou (JP); Susumu MIYAZAKI, Machida (JP); Mitsuaki YABUKI, Kawasaki (JP)

(73) Assignee: FUJITSU LIMITED, Kawasaki-shi (JP)

(21) Appl. No.: 17/086,489

(22) Filed: Nov. 2, 2020

(30) Foreign Application Priority Data
Nov. 29, 2019 (JP) 2019-217050

(51) Int. Cl. H04N 21/218; H04N 5/247; G06T 7/70; G06K 9/00; G06T 5/00

(52) U.S. Cl. CPC H04N 21/21805; H04N 5/247; G06T 7/70; G06K 9/00724; G06K 2009/00738; G06K 9/00362; G06T 5/006; G06T 2207/30196; G06T 2207/10016; G06K 9/00765

(57) ABSTRACT

A non-transitory computer-readable storage medium storing a program that causes a computer to execute a process, the process includes receiving first positional information of each of a plurality of players, the first positional information being identified based on first video information captured by a plurality of first cameras installed in a field where the plurality of players play a competition; acquiring second video information from a second camera that captures a video image of the competition; when accepting identification information of a specific player among the plurality of players, converting first positional information of the specific player when and after the identification information is accepted, to second positional information in the second video information; generating third video information that is a partial area cut out from the second video information based on the second positional information obtained by the conversion; and outputting the third video information.

### CROSS-REFERENCE TO RELATED APPLICATION

This application is based on and claims the benefit of priority of the prior Japanese Patent Application No. 2019-217050, filed on Nov. 29, 2019, the entire contents of which are incorporated herein by reference.

### FIELD

The embodiments discussed herein are related to a storage medium and so on.

### BACKGROUND

FIG. 23 is a diagram illustrating an example of a related-art broadcasting system. In the related-art broadcasting system, plural pieces of video information are captured by cameras C1, C2, and C3, respectively. By way of example, the case of broadcasting a basketball game over the Internet will now be described. In the related-art broadcasting system, the cameras C1 to C3 capture images when operated by the respective camera operators.

The camera C1 is a camera that captures bird's-eye view video images of a court 1. The camera C2 is a camera that captures video information on a scene close to a player or the like. The camera C3 is a camera that captures video information on an area under the goal. The respective pieces of video information of the cameras C1 to C3 are output to a switcher 2. The switcher 2 is coupled to a server 3. The server 3 transmits video information to terminal devices (not illustrated) of viewers.

FIG. 24 illustrates video information captured by each camera. Video information M1-1, M1-2, or M1-3 is video information captured by the camera C1. A camera operator operates the camera C1 to change the camera shooting direction and to zoom in or out the camera C1. For example, when the camera operator moves the camera C1 horizontally, video information changes from the video information M1-1 to the video information M1-2. When the camera operator performs a zoom-up operation, video information changes from the video information M1-2 to the video information M1-3.

The video information M2 is video information captured by the camera C2. The camera operator operates the camera C2 so that a specific player appears. For example, when confirming that the specific player has scored a goal, the camera operator captures a close-up video image of the specific player.

The video information M3 is video information captured by the camera C3. The camera operator operates the camera C3 to capture video information of an area under the goal.

The switcher 2 is a device that selects video information to be output to the server 3, among the respective pieces of video information output from the cameras C1 to C3, and is operated by an administrator. For example, by operating the switcher 2, the administrator first selects the video information of the camera C1, and thus outputs, to the server 3, the pieces of video information M1-1, M1-2, and M1-3 representing motions of both the offensive players and the defensive players. Subsequently, when confirming that a specific player has scored a goal, the administrator selects the video information of the camera C2 and outputs, to the server 3, the video information M2 of the player who has scored a goal. This enables viewers to sequentially view the pieces of video information M1-1, M1-2, M1-3, and M2.

There is another related-art technique that detects a crowd of people included in a video image, using video information, and automatically controls a photographic apparatus so that the crowd of people is included in the video information. Related-art techniques are disclosed in, for example, Japanese Laid-open Patent Publication Nos. 2006-312088, 2010-183301, 2015-070503, 2001-230993, and 2009-153144.

### SUMMARY

According to an aspect of the embodiments, a non-transitory computer-readable storage medium storing a program that causes a computer to execute a process, the process includes receiving first positional information of each of a plurality of players, the first positional information being identified based on first video information captured by a plurality of first cameras installed in a field where the plurality of players play a competition; acquiring second video information from a second camera that captures a video image of the competition; when accepting identification information of a specific player among the plurality of players, converting first positional information of the specific player when and after the identification information is accepted, to second positional information in the second video information; generating third video information that is a partial area cut out from the second video information based on the second positional information obtained by the conversion; and outputting the third video information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a video image generation system according to a first embodiment;

FIG. 2 is a diagram illustrating processing of a second server according to the first embodiment;

FIG. 3 is a functional block diagram illustrating a configuration of a first server according to the first embodiment;

FIG. 4 depicts an example of a data structure of a first video buffer;

FIG. 5 depicts an example of a data structure of a tracking table;

FIG. 6 is a functional block diagram illustrating a configuration of a second server according to the first embodiment;

FIG. 7 depicts an example of a data structure of a tracking information buffer;

FIG. 8A depicts an example of a data structure of a second video buffer;

FIG. 8B depicts an example of a data structure of a bird's-eye view video information buffer;

FIG. 8C depicts an example of a data structure of a conversion table;

FIG. 8D depicts an example of a data structure of a third video information buffer;

FIG. 9 is a diagram illustrating processing of generating bird's-eye view video information;

FIG. 10 is a diagram (1) illustrating processing of generating third video information, the processing being performed by a generation unit;

FIG. 11 is a diagram (2) illustrating processing of generating third video information, the processing being performed by a generation unit;

FIG. 12 is a functional block diagram illustrating a configuration of a video distribution server according to the first embodiment;

FIG. 13 is a flowchart illustrating a processing procedure of a first server according to the first embodiment;

FIG. 14A is a flowchart illustrating a processing procedure of a second server according to the first embodiment;

FIG. 14B is a flowchart illustrating a processing procedure of a video distribution server according to the first embodiment;

FIG. 15 is a diagram illustrating processing of a detection unit;

FIG. 16 illustrates an example of a video image generation system according to a second embodiment;

FIG. 17 is a functional block diagram illustrating a configuration of a second server according to the second embodiment;

FIG. 18 is a functional block diagram illustrating a configuration of a video distribution server according to the second embodiment;

FIG. 19A is a flowchart illustrating a processing procedure of a second server according to the second embodiment;

FIG. 19B is a flowchart illustrating a processing procedure of a second server according to the second embodiment;

FIG. 20 illustrates an example of a hardware configuration of a computer that achieves functions similar to those of a first server;

FIG. 21 illustrates an example of a hardware configuration of a computer that achieves functions similar to those of a second server;

FIG. 22 illustrates an example of a hardware configuration of a computer that achieves functions similar to those of a video distribution server;

FIG. 23 is a diagram illustrating an example of a related-art broadcasting system; and

FIG. 24 illustrates video information captured by each camera.

### DESCRIPTION OF EMBODIMENTS

In the related-art techniques described above, however, a problem arises in that it may not be possible to automatically generate video information on a specific player from video information on the entire area of the field where a plurality of players play a competition.

For example, in the related-art broadcasting systems, video information on a specific player is generated when a camera operator, who operates a camera, autonomously captures video images of the specific player. For example, a camera operator who operates the camera C2 determines to capture a close-up video image of a player who has scored a goal, so that a close-up video image of the specific player is generated. For example, video information on the specific player is not automatically generated from video information on the entire area of the field where a plurality of players play a competition. Even using the related-art technique of detecting a crowd of people, it may not be possible to automatically generate video information representing the specific player.

In view of the above, it is desirable that video information on the specific player be automatically generated from video information on the entire area of the field where a plurality of players play a competition.

Embodiments of a video image generation program, a video image generation method, and a video image generation system disclosed in the present application will be described in detail below with reference to the accompanying drawings. The present disclosure is not limited to the embodiments.

### First Embodiment

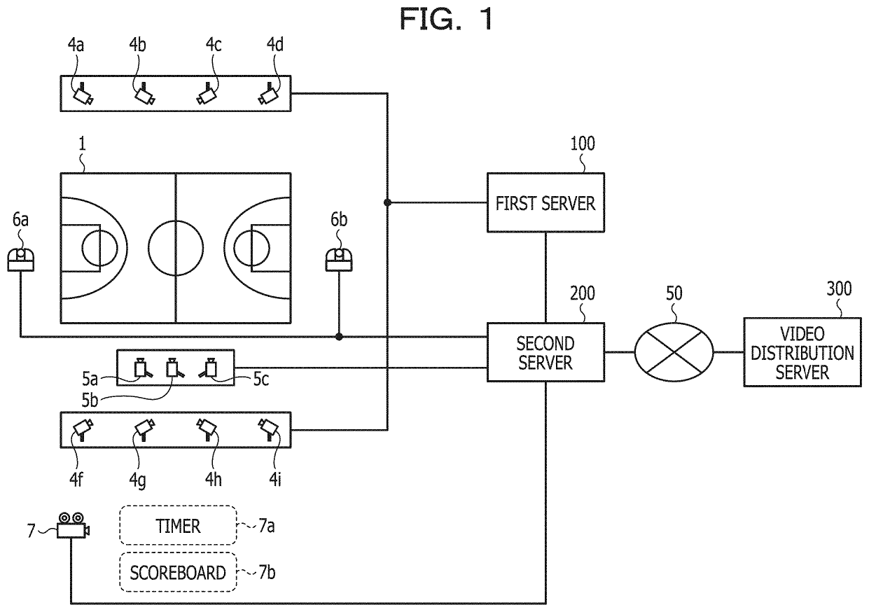

FIG. 1 illustrates an example of a video image generation system according to a first embodiment. As illustrated in FIG. 1, the video image generation system includes first cameras 4a to 4i, second cameras 5a, 5b, and 5c, third cameras 6a and 6b, a fourth camera 7, and a fifth camera. The video image generation system also includes a first server 100, a second server 200, and a video distribution server 300.

The first cameras 4a to 4i are coupled to the first server 100. The first cameras 4a to 4i are collectively referred to as “first cameras 4”. The second cameras 5a to 5c are coupled to the second server 200. The second cameras 5a to 5c are collectively referred to as “second cameras 5”. The third cameras 6a and 6b are coupled to the second server 200. The third cameras 6a and 6b are collectively referred to as “third cameras 6”. The fourth camera 7 is coupled to the second server 200. The first server 100 and the second server 200 are coupled to each other. The second server 200 and the video distribution server 300 are coupled to each other via a network (closed network) 50.

In the court 1, a plurality of players (not illustrated) play a competition. In the first embodiment, a description will be given of the case in which players play a basketball game in the court 1. However, the present disclosure is not limited to this. For example, the present disclosure may be applied to, in addition do basketball, athletic events such as soccer, volleyball, baseball, and track and field, dances, and so on.

The first camera 4 is a camera (such as a 2K camera) that outputs, to the first server 100, video information in a shooting range captured at a certain frame rate (frames per second (FPS)). Hereafter, video information captured by the first camera 4 will be referred to as “first video information”. The first video information is used for identifying the positional information of each of players. The positional information of each of the players indicates a three-dimensional position in the reference space. The first video information is provided with a camera identifier (ID), which uniquely identifies the camera 4 that has captured the first video information, and the time point information of each frame.

The second camera 5 is a camera (such as a 4K camera or an 8K camera) that outputs, to the second server 200, video information in the shooting range captured at the certain frame rate (FPS). Hereafter, video information captured by the second camera 5 will be referred to as “partial video information”. The shooting range made of a combination of the shooting range of the second camera 5a, the shooting range of the second camera 5b, and the shooting range of the second camera 5c is assumed to cover the entire area of the court 1. The partial video information is provided with a camera ID, which uniquely identifies the camera 5 that has captured the partial video information, and the time point information of each frame. Bird's-eye view video information is generated by coupling together pieces of partial video information. The bird's-eye view video information corresponds to “second video information”.

The third camera 6 is a camera (2K camera) that is installed under the goal of the court 1 and outputs, to the second server 200, video information in a shooting range captured at a certain frame rate (FPS). Hereafter, video information captured by the third camera 6 will be referred to as “under-goal video information”.

The fourth camera 7 is a camera that includes, in the shooting range, a timer 7a and a scoreboard 7b. The timer 7a is a device that displays the current time point and the elapsed time of a game. The scoreboard 7b is a device that displays the score in a game. Hereafter, video information captured by the fourth camera 7 will be referred to as “score video information”. The timer 7a and the scoreboard 7b may be an integrated device.

The first server 100 is a device that acquires first video information from the first cameras 4, and sequentially identifies the positional information of each of a plurality of players, based on the first video information. The positional information of each of the plurality of players identified by the first server 100 is referred to as “first positional information”. The first positional information indicates a three-dimensional position in the reference space. The first server 100 transmits “tracking information” in which information identifying time, such as frame rates, the first positional information, and identification information uniquely identifying a player are associated with each other, to the second server 200.

The second server 200 acquires tracking information from the first server 100 and acquires plural pieces of partial video information from the second cameras 5. The second server 200 generates bird's-eye view video information from the plural pieces of partial video information. When accepting the identification information of a specific player among a plurality of players, using the tracking information, the second server 200 sequentially converts the positional information of the specific player when and after the identification information is accepted, to the positional information in the bird's-eye view video information (hereafter referred to as second positional information). The second server 200 generates third video information that is a partial area cut out from the bird's-eye view video information, in accordance with the second positional information. The second server 200 transmits the generated third video information to the video distribution server 300. The second positional information is a two-dimensional position in the reference plane.

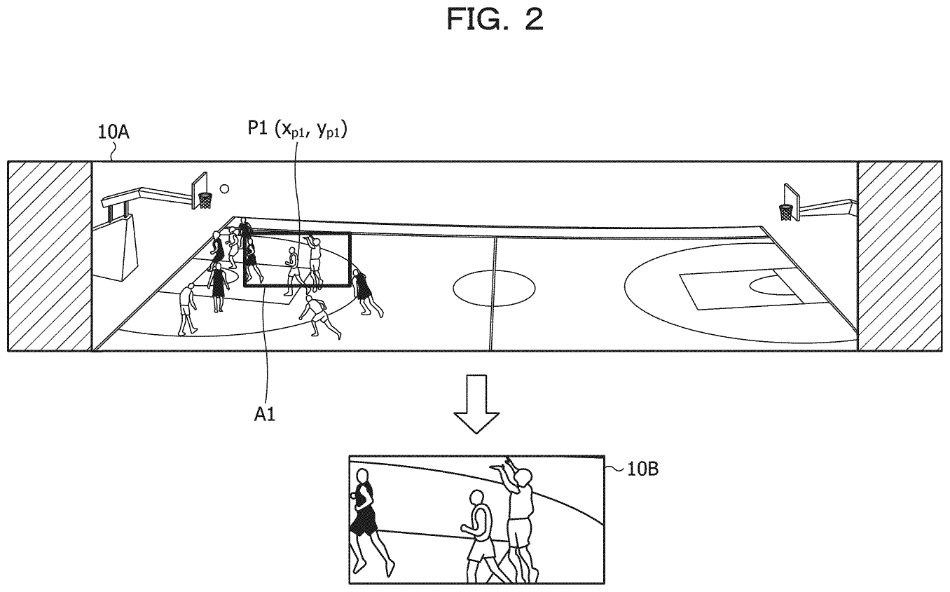

FIG. 2 is a diagram illustrating processing of a second server according to the first embodiment. The bird's-eye view video information 10A illustrated in FIG. 2 is video information obtained by coupling together the respective pieces of partial video information captured by the second cameras 5. For example, the case where the second server 200 has accepted the identification information of a player P1 will be described. The second server 200 compares the identification information of the player P1 with tracking information and identifies first positional information corresponding to the player P1. The second server 200 converts the first positional information corresponding to the player P1 to second positional information (x_{P1}, y_{P1}) in the bird's-eye view video information 10A.

The second server 200 cuts out a partial area Al from the bird's-eye view video information 10A, in accordance with the second positional information (x_{P1}, y_{P1}). The second server 200 generates the video information on the cut-out area Al as third video information 10B. For example, the resolution of the bird's-eye view video information 10A is 4K, and the resolution of the third video information 10B is 2K or high definition (HD). After the identification information of a specific player has been specified, the second server 200 sequentially identifies the second positional information of the specific player for a predetermined time period using tracking information, and cuts out a partial area of the bird's-eye view video information 10A in accordance with the second positional information to generate the third video information.

The video distribution server 300 is a device that receives third video information from the second server 200 and distributes the third video information to terminal devices (not illustrated) of viewers.

In such a way, in the video image generation system according to the first embodiment, the first server 100 generates tracking information based on the first video information. When accepting the identification information of a specific player, the second server 200 converts the first positional information of the specific player who may be identified using tracking information, to the second positional information in the bird's-eye view video information. The second server 200 generates third video information, which is a partial area cut out from the bird's-eye view video information in accordance with the second positional information of the specific player. Thus, third video information on the specific player may be automatically generated from the second video information on the entire area of the court 1 where a plurality of players play a competition. For example, the video information on a specific player has been generated by a camera operator or the like who operates the camera C2. The camera operator or the like takes a close-up video image and the like of the specific player to generate the video information on the specific player. However, the video image generation system according to the present embodiment may automatically generate the video information on the specific player.

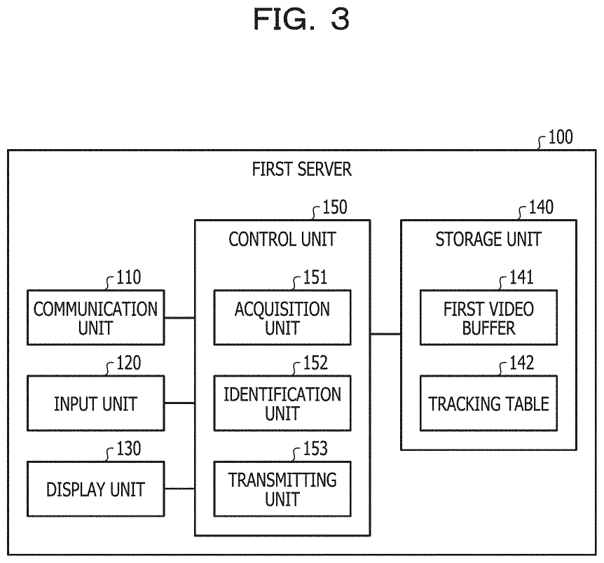

An example of a configuration of the first server 100 illustrated in FIG. 1 will now be described. FIG. 3 is a functional block diagram illustrating a configuration of a first server according to the first embodiment. As illustrated in FIG. 3, the first server 100 includes a communication unit 110, an input unit 120, a display unit 130, a storage unit 140, and a control unit 150.

The communication unit 110 is a processing unit that performs information communication with the first cameras 4 and the second server 200. The communication unit 110 corresponds to a communication device, such as a network interface card (NIC). For example, the communication unit 110 receives first video information from the first camera 4. The control unit 150 described later exchanges information with the first cameras 4 and the second server 200 via the communication unit 110.

The input unit 120 is an input device that inputs various types of information to the first server 100. The input unit 120 corresponds to a keyboard, a mouse, a touch panel, and the like.

The display unit 130 is a display device that displays information output from the control unit 150. The display unit 130 corresponds to a liquid crystal display, an organic electro-luminescence (EL) display, a touch panel, or the like.

The storage unit 140 includes a first video buffer 141 and a tracking table 142. The storage unit 140 corresponds to a semiconductor memory element, such as a random-access memory (RAM) or a flash memory, or a storage device, such as a hard disk drive (HDD).

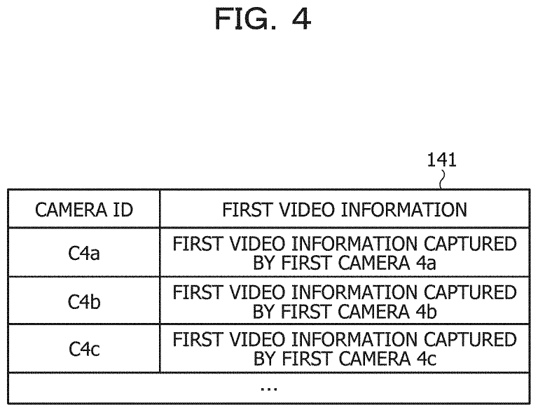

The first video buffer 141 is a buffer that holds first video information captured by the first camera 4. FIG. 4 depicts an example of a data structure of a first video buffer. As illustrated in FIG. 4, the first video buffer 141 associates a camera ID with first video information. The camera ID is information that uniquely identifies the first camera 4. For example, the camera IDs corresponding to the first cameras 4a to 4i are camera IDs “C4a to C4i”, respectively. The first video information is video information captured by the first camera 4 of interest.

The first video information includes a plurality of image frames arranged in the time sequence. An image frame is data of one frame of a still image. An image frame included in the first video information is referred to as a “first image frame”. Each first image frame is provided with the time point information.

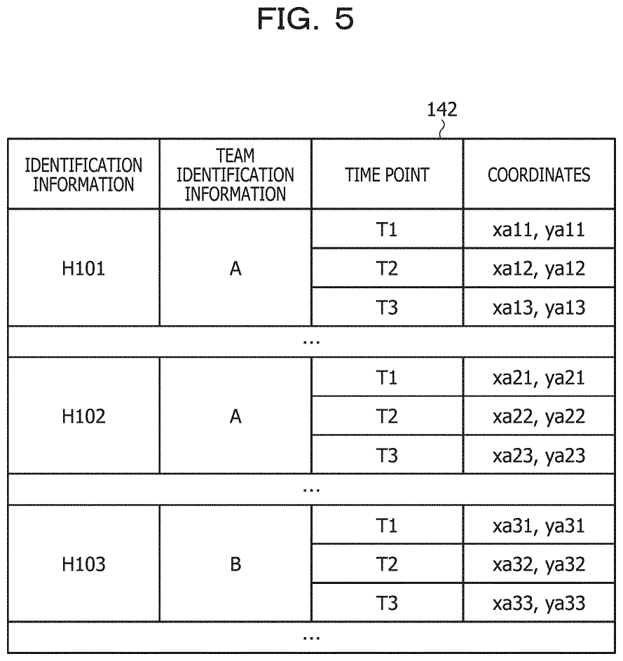

The tracking table 142 is a table that holds information on positional coordinates (paths of travel) at time points for players. FIG. 5 is a table of a data structure of a tracking table. As illustrated in FIG. 5, the tracking table 142 associates identification information, team identification information, a time point, and coordinates with each other.

The identification information is information that uniquely identifies a player. The team identification information is information that uniquely identifies a team to which the player belongs. The time point is information indicating the time point of a first image frame in which the player is detected.

The coordinates indicate the coordinates of the player and correspond to the first positional information. For example, a player with player identification information “H101” belonging to team identification information “A” is positioned at coordinates “xa11, ya11” at a time point “T1”.

Referring back to FIG. 3, the control unit 150 includes an acquisition unit 151, an identification unit 152, and a transmitting unit 153. The control unit 150 may be implemented as a central processing unit (CPU), a microprocessor unit (MPU), or the like. The control unit 150 may be implemented as a hard-wired logic circuit, such as an application-specific integrated circuit (ASIC) or a field-programmable gate array (FPGA).

The acquisition unit 151 is a processing unit that acquires first video information from the first cameras 4. The acquisition unit 151 stores the acquired first video information in the first video buffer 141. The acquisition unit 151 stores first video information in the first video buffer 141 in such a manner that the first video information is associated with the camera ID of the first camera 4. The acquisition unit 151 corresponds to a “first acquisition unit”.

The identification unit 152 is a processing unit that sequentially identifies the first positional information of each of a plurality of players based on first video information stored in the first video buffer 141. Based on an identified result, the identification unit 152 registers the identification information, team identification information, time points, and coordinates of players in association with each other in the tracking table 142. A description will be given below of an example of processing in which the identification unit 152 identifies the first positional information of some player included in the first video information (first image frame). The first video information is first video information captured by the first camera 4a. The processing of identifying the first positional information of a player is not limited to the processing described below.

The identification unit 152 generates a difference image between a first image frame at a time point T1 and a first image frame at a time point T2, from the first video information in the first video buffer 141. The identification unit 152 compares the area of a region remaining in the difference image with a template that defines the area of a player, and detects, as a player, a region in the difference image where the difference of the area of this region from the area of the template is less than a threshold.

The identification unit 152 converts the coordinates (coordinates in the first image frame) of a player calculated from the difference image, to the entire coordinates using a conversion table (not illustrated). The conversion table is a table that defines correspondence relationship between the coordinates in the first image frame captured by one first camera 4 (for example, the first camera 4a) and the entire coordinates common to all the first cameras 4a to 4i, and is assumed to be set in advance. The position indicated by such entire coordinates becomes the first positional information of a player.

The identification unit 152 assigns the identification information of a player detected from the first image frame. For example, the identification unit 152 assigns the identification information of a player, using features of the uniform (the uniform number and the like) of each player set in advance. The identification unit 152 identifies the team identification information of the player detected from the first image frame, using the features of the uniform of each team set in advance.

The identification unit 152 performs the processing described above and registers the identification information, team identification information, time points, and coordinates (entire coordinates) of the player in association with each other in the tracking table 142. The identification unit 152 performs the processing described above for each player by using the other first cameras 4b to 4i and thus registers the identification information, team identification information, time points, and coordinates of each player in association with each other in the tracking table 142. The identification unit 152 performs the processing described above repeatedly at each time point.

The transmitting unit 153 is a processing unit that transmits, to the second server 200, tracking information including the first positional information of each player. The tracking information includes the identification information, team identification information, information (such as time points, frame rates, and the like) for identifying a time period, coordinates (first positional information) of each player.

In the tracking table 142, for each player, a time point and the coordinates (first positional information) indicating the position where the player is at the time point are registered by the identification unit 152. The transmitting unit 153 generates, at each time point, tracking information including the identification information, team identification information, and time points, coordinates (first positional information) of each player who has been newly registered, and sequentially transmits the generated tracking information to the second server 200.

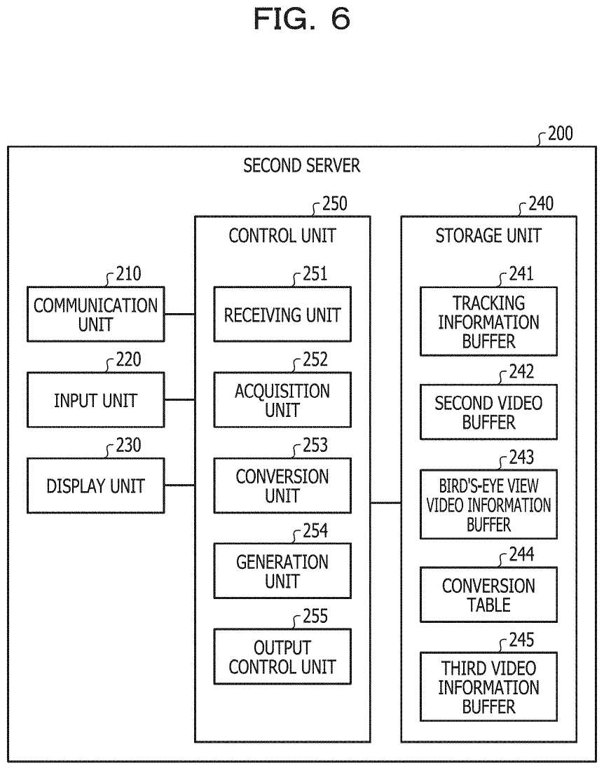

An example of a configuration of the second server 200 illustrated in FIG. 1 will now be described. FIG. 6 is a functional block diagram illustrating a configuration of a second server according to the first embodiment. As illustrated in FIG. 6, the second server 200 includes a communication unit 210, an input unit 220, a display unit 230, a storage unit 240, and a control unit 250.

The communication unit 210 is a processing unit that performs data communication with the second cameras 5, the third cameras 6, the fourth camera 7, the first server 100, and the video distribution server 300. The communication unit 210 corresponds to a communication device, such as an NIC. For example, the communication unit 210 receives partial video information from the second camera 5. The communication unit 210 receives under-goal video information from the third camera 6. The communication unit 210 receives score video information from the fourth camera 7. The communication unit 210 receives tracking information from the first server 100. The control unit 250 described later exchanges information with the second cameras 5, the third cameras 6, the fourth camera 7, the first server 100, and the video distribution server 300 via the communication unit 210.

The input unit 220 is an input device that inputs various types of information to the second server 200. The input unit 220 corresponds to a keyboard, a mouse, a touch panel, and the like. As described later, the administrator may operate the input unit 220 to input the identification information of a specific player. The administrator may operate a switch unit 345 of the video distribution server 300 to specify a specific player. In this case, the communication unit 210 of the second server 200 receives the identification information of the specific player selected by the administrator, from a communication unit 310 of the video distribution server 300.

The display unit 230 is a display device that displays information output from the control unit 250. The display unit 230 corresponds to a liquid crystal display, an organic EL display, a touch panel, or the like.

The storage unit 240 includes a tracking information buffer 241, a second video buffer 242, a bird's-eye view video information buffer 243, a conversion table 244, and a third video information buffer 245. The storage unit 240 corresponds to a semiconductor memory element, such as a RAM or a flash memory, or a storage device, such as an HDD.

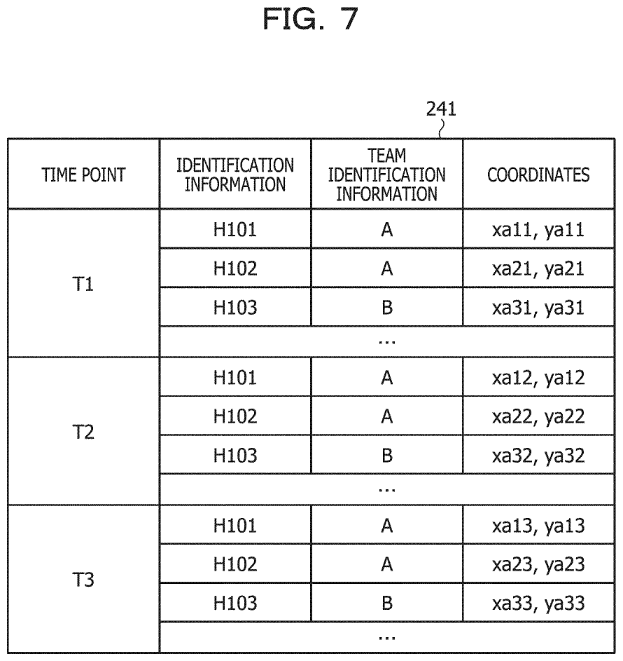

The tracking information buffer 241 is a buffer that holds tracking information transmitted from the first server 100. FIG. 7 depicts an example of a data structure of a tracking information buffer. As depicted in FIG. 7, the tracking information buffer 241 associates a time point, identification information, team identification information, and coordinates with each other. The time point is information indicating the time point of a first image frame in which a player is detected. The identification information is information that uniquely identifies a player. The team identification information is information that identifies a team. The coordinates indicate the coordinates of a player and correspond to the first positional information.

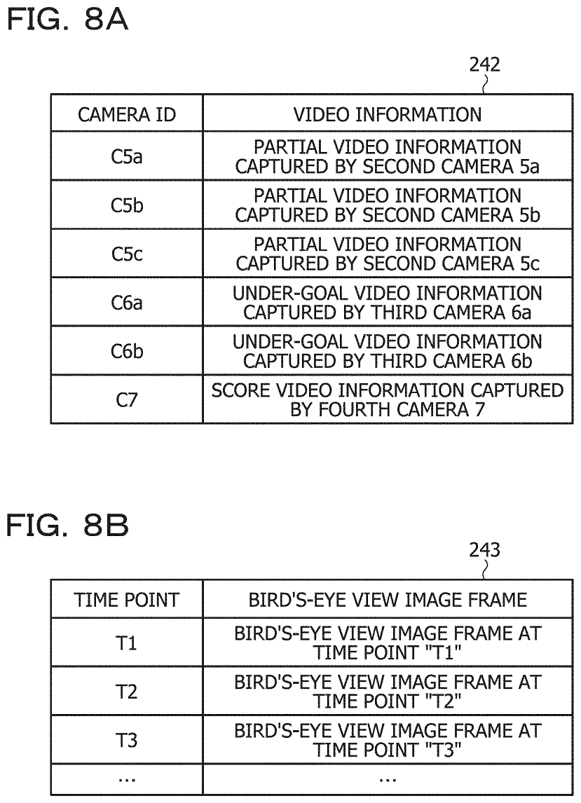

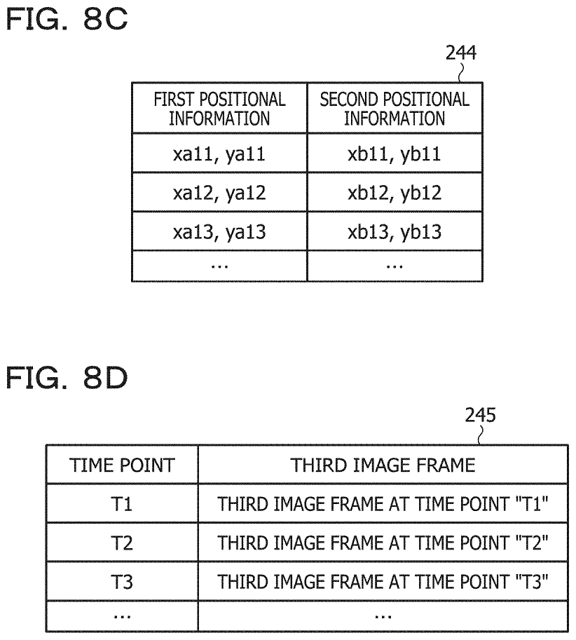

The second video buffer 242 is a buffer that individually holds the partial video information captured by the second camera 5, the under-goal video information captured by the third camera 6, and the score video information captured by the fourth camera 7. FIG. 8A depicts an example of a data structure of a second video buffer. As illustrated in FIG. 8A, the second video buffer 242 includes camera IDs and video information.

The camera ID is information that uniquely identifies the second camera 5, the third camera 6, or the fourth camera 7. For example, the camera IDs corresponding to the second cameras 5a to 5c are assumed as camera IDs “C5a to C5c”, respectively. The camera IDs corresponding to the third cameras 6a and 6b are assumed as camera IDs “C6a and C6b”, respectively. The camera ID corresponding to the fourth camera 7 is assumed as a camera ID “C7”.

The video information captured by the second camera 5 is partial video information. The partial video information includes image frames arranged in the time sequence. An image frame included in the partial video information is referred to as a “partial image frame”. Each partial image frame is provided with the time point information.

The video information captured by the third camera 6 is under-goal video information. The under-goal video information includes image frames arranged in the time sequence, and each of the image frames is provided with the time point information. The video information captured by the fourth camera 7 is score video information. The score video information includes image frames arranged in the time sequence, and each of the image frames is provided with the time point information.

The time point information of an image frame of the first video information (a first image frame), the time point information of an image frame of the partial video information (a partial image frame), the time point information of an image frame of the under-goal video information, and the time point information of an image frame of the score video information are assumed to be in synchronization with each other.

Referring back to FIG. 6, the bird's-eye view video information buffer 243 is a buffer that stores bird's-eye view video information. The bird's-eye view video information includes image frames arranged in the time sequence. An image frame included in the bird's-eye view video information is referred to as a “bird's-eye view image frame”. FIG. 8B depicts an example of a data structure of a bird's-eye view video information buffer. As depicted in FIG. 8B, in the bird's-eye view video information buffer 243, a time point and a bird's-eye view image frame are associated with each other. For example, the bird's-eye view image frame at a time point Tn is an image frame in which the partial image frames captured at the time point Tn by the second cameras 5 are coupled together. The character n denotes a natural number.

The conversion table 244 is a table that defines the relationship between the first positional information and the second positional information. FIG. 8C depicts an example of a data structure of a conversion table. As depicted in FIG. 8C, in the conversion table 244, the first positional information and the second positional information are associated with each other. The first positional information corresponds to the coordinates of a player included in the tracking information transmitted from the first server 100. The second positional information corresponds to the coordinates in a bird's-eye view image frame (bird's-eye view video information). For example, first positional information “xa11, ya11” is associated with second positional information “xb11, yb11”.

The third video information buffer 245 is a buffer that stores third video information. The third video information includes image frames arranged in the time sequence. An image frame included in the third video information is referred to as a “third image frame”. FIG. 8D depicts an example of a data structure of a third video information buffer. As depicted in FIG. 8D, in the third video information buffer 245, a time point and a third image frame are associated with each other.

The control unit 250 includes a receiving unit 251, an acquisition unit 252, a conversion unit 253, a generation unit 254, and an output control unit 255. The control unit 250 may be implemented as a CPU, an MPU, or the like. The control unit 250 may be implemented as a hard-wired logic circuit, such as an ASIC or an FPGA.

The receiving unit 251 is a processing unit that sequentially receives tracking information from the first server 100. The receiving unit 251 sequentially stores the received tracking information in the tracking information buffer 241. As described above, the tracking information includes the identification information, team identification information, time points, and coordinates (first positional information) of each player.

The acquisition unit 252 is a processing unit that acquires partial video information from the second camera 5. The acquisition unit 252 stores the acquired partial video information in the second video buffer 242. In the case of storing partial video information in the second video buffer 242, the acquisition unit 252 stores the partial video information and the camera ID of the second camera 5 in association with each other. The acquisition unit 252 corresponds to a “second acquisition unit”.

The acquisition unit 252 acquires under-goal video information from the third camera 6. In the case of storing the acquired under-goal video information in the second video buffer 242, the acquisition unit 252 stores the under-goal video information and the camera ID of the third camera 6 in association with each other.

The acquisition unit 252 acquires score video information from the fourth camera 7. In the case of storing the acquired score video information in the second video buffer 242, the acquisition unit 252 stores the score video information and the camera ID of the fourth camera 7 in association with each other.

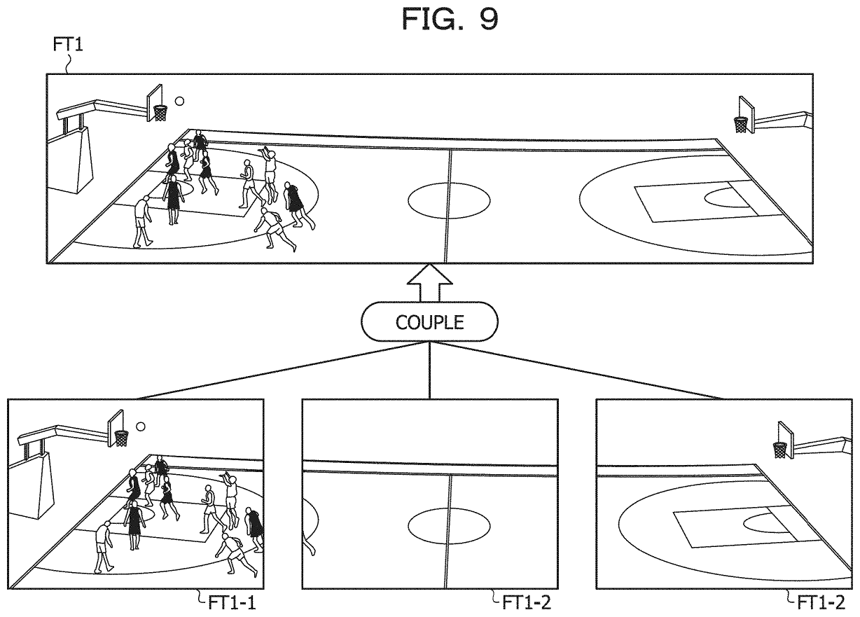

The acquisition unit 252 generates bird's-eye view video information from plural pieces of partial video information stored in the second video buffer 242. FIG. 9 is a diagram illustrating processing of generating bird's-eye view video information. Referring to FIG. 9, a description is given using partial image frames FT1-1, FT1-2, and FT1-3, by way of example. The partial image frame FT1-1 is a partial image frame at the time point T1 included in partial video information captured by the second camera 5a. The partial image frame FT1-2 is a partial image frame at the time point T1 included in partial video information captured by the second camera 5b. The partial image frame FT1-3 is a partial image frame at the time point T1 included in partial video information captured by the second camera 5c.

The acquisition unit 252 generates a bird's-eye view image frame FT1 at the time point T1 by coupling the partial image frames FT1-1, FT1-2, and FT1-3 together. By repeatedly performing the processing described above at each time point, the acquisition unit 252 generates bird's-eye view image frames in the time sequence to generate bird's-eye view video information. The acquisition unit 252 stores the bird's-eye view video information in the bird's-eye view video information buffer 243.

The acquisition unit 252 may correct the distortion of each of the partial image frames and then couple partial image frames together, thereby generating a bird's-eye view image frame. For example, it is assumed that the second camera 5b includes, in the shooting range, the center portion of the court 1, and the second cameras 5a and 5c include, in the shooting ranges, areas on the left and right of the center of the court 1. In this case, distortions may occur at ends of partial image frames captured by the second cameras 5a and 5c. The acquisition unit 252 corrects distortions at the ends of partial image frames captured by the second cameras 5a and 5c, using a distortion correction table (not illustrated). The distortion correction table is a table that defines the relationship between the position of a pixel before distortion correction and the position of a pixel after the distortion correction. The information of the distortion correction table is assumed to be set in advance.

The conversion unit 253 is a processing unit that, when accepting identification information of a specific player among a plurality of players, sequentially converts the first positional information of the specific player when and after the identification information is accepted, to the second positional information. The conversion unit 253 outputs the second positional information obtained by the conversion to the generation unit 254. Hereafter, the identification information of a specific player will be referred to as “specific identification information”. The conversion unit 253 accepts specific identification information via a network from the video distribution server 300 described later. The administrator may input specific identification information by operating the input unit 220, and the conversion unit 253 may accept the specific identification information. When the first server 100 has a function of automatically recognizing that a goal has been scored, in recognizing that a goal has been scored, the first server 100 may transmit the identification information of a player who has scored the goal, to the second server 200, and thus the conversion unit 253 may accept the identification information of the specific player. The processing of recognizing a goal is performed, for example, by the following method. Using the first video information, the first server 100 tracks the position of a ball and tracks the position of each player. The first server 100 detects the scored goal when a ball has passed through a goal area (area set in advance). After detecting the scored goal, the first server 100 tracks back the path of the ball so as to determine which player has been at the position of the ball shooting. The first server 100 thus recognizes that the player who shot the ball has scored the goal. The first server 100 transmits the identification information of the player to the second server 200.

For example, the case where, at the time point T1, the conversion unit 253 has accepted specific identification information “H101” will be described. The conversion unit 253 references the tracking information buffer 241 and acquires the coordinates (first positional information) of specific identification information “H101” at the time point T1. The conversion unit 253 compares the acquired first positional information with the conversion table 244 and identifies second positional information corresponding to the first positional information. After accepting the specific identification information, the conversion unit 253 sequentially converts the first positional information to the second positional information for a predetermined time period (from the time point T1 to a time point Tm) and time-sequentially outputs the second positional information to the generation unit 254. The character m is a numerical value set in advance.

The conversion unit 253 identifies the positional information crowded with players. The positional information crowded with players is referred to as “crowded positional information”.

An example of the processing of identifying crowded positional information will be described below. If specific identification information is not accepted at the time point Tn, the conversion unit 253 acquires the respective pieces of first positional information of all the players at the time point Tn from the tracking information buffer 241. The conversion unit 253 assigns players who are close in distance to each other, to the same cluster, based on the respective pieces of first positional information of all the players, such that the players are classified into a plurality of clusters.

The conversion unit 253 selects a cluster including the largest number of players among the plurality of clusters and calculates, as crowded positional information, the center of the respective pieces of first positional information of players included in the selected cluster. The conversion unit 253 compares the crowded positional information with the conversion table 244 and identifies second positional information corresponding to the crowded positional information. Hereafter, the second positional information corresponding to the crowded positional information will be referred to as “crowded second positional information”. The conversion unit 253 sequentially calculates the crowded second positional information and time-sequentially outputs the calculated crowded second positional information to the generation unit 254.

The generation unit 254 is a processing unit that generates third video information. The third video information is a partial area cut out from the bird's-eye view video information in accordance with the second positional information obtained by the conversion sequentially performed by the conversion unit 253. Third video information related to a crowded area is an example of different video information. The generation unit 254 stores the generated third video information in the third video information buffer 245. Hereafter, a partial area of bird's-eye view video information (bird's-eye view image frames) in accordance with the second positional information will be referred to as a “target area”.

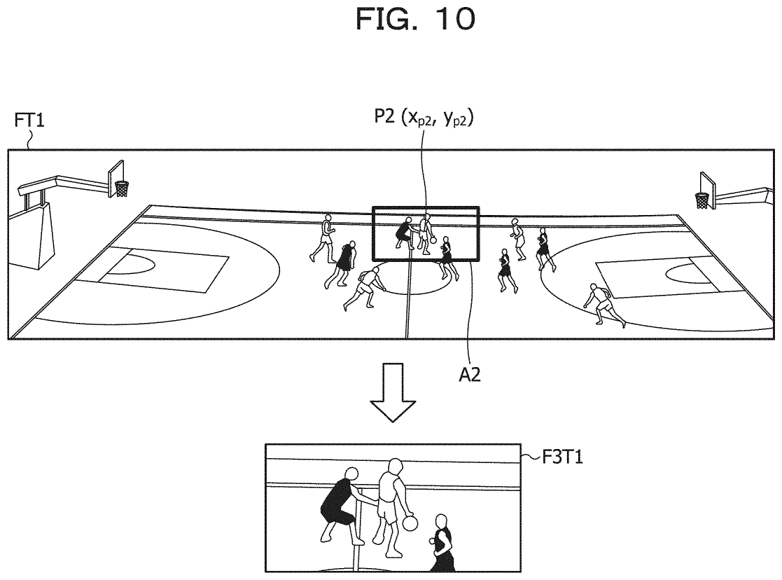

FIG. 10 is a diagram (1) illustrating processing of generating third video information, the processing being performed by a generation unit. A description will now be given using the bird's-eye view image frame FT1 at the time point T1 included in the bird's-eye view video information. The player corresponding to the specific identification information is a player P2, and the second positional information of the player P2 at the time point T1 is (x_{P2}, y_{P2}).

The generation unit 254 cuts out a target area A2 from the bird's-eye view image frame FT1, in accordance with the second positional information (x_{P2}, y_{P2}). The generation unit 254 generates the information on the cut-out target area A2 as a third image frame F3T1. The size of the target area is set in advance. The generation unit 254 aligns the center of the target area with the coordinates of the second positional information to identify the location of the target area. The generation unit 254 may perform magnification control within a magnification range set in advance so that the size of a player corresponding to the specific identification information is as large as possible. The generation unit 254 generates third image frames by repeatedly performing the processing described above for a predetermined time period during which the generation unit 254 accepts the second positional information from the conversion unit 253, and sequentially stores the third image frames in the third video information buffer 245.

The generation unit 254 accepts the crowded second positional information from the conversion unit 253. In accordance with the crowded second positional information, the generation unit 254 sets a partial area to be cut out in the bird's-eye view image frame. Hereafter, a partial area to be cut out, which is set in accordance with the crowded second positional information, is referred to as a “crowded area”. The generation unit 254 generates a third image frame by cutting out information on a crowded area from a bird's-eye view image frame.

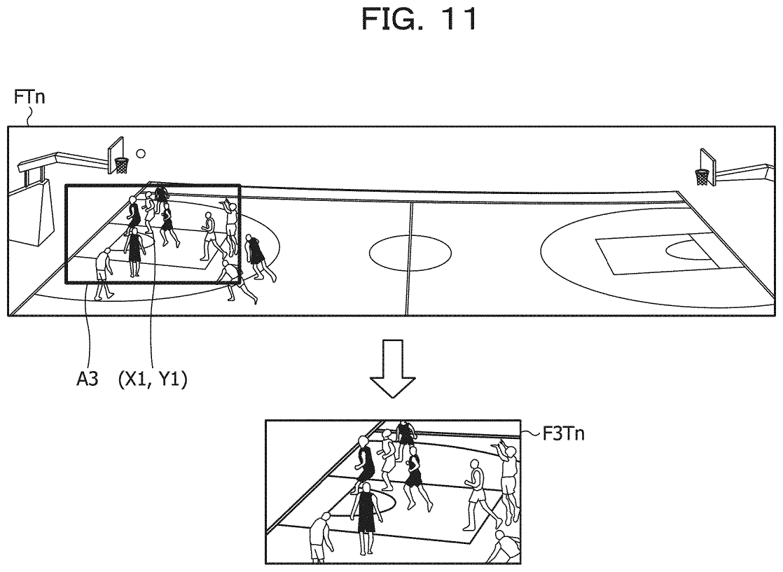

FIG. 11 is a diagram (2) illustrating processing of generating third video information, the processing being performed by a generation unit. A description will now be given using a bird's-eye view image frame FTn at the time point Tn included in the bird's-eye view video information. The crowded second positional information is designated as (X1, Y1).

In accordance with the crowded second positional information (X1, Y1), the generation unit 254 cuts out a crowded area A3 in the bird's-eye view image frame FTn. The generation unit 254 generates the information on the cut-out crowded area A3 as a third image frame F3Tn. The size of the crowded area A3 is set in advance. The generation unit 254 may perform magnification control within a magnification range set in advance so that as many players as possible are included in the crowded area A3.

The generation unit 254 aligns the center of the crowded area with the coordinates of the crowded second positional information to identify the location of the target area. If a predetermined time period has elapsed since the specific identification information was accepted, or if the specific identification information has not been accepted, the generation unit 254 generates third image frames and sequentially stores the third image frames in the third video information buffer 245.

The output control unit 255 is a processing unit that outputs the third video information stored in the third video information buffer 245, to the video distribution server 300. The output control unit 255 may output the under-goal video information and score video information stored in the second video buffer 242 to the video distribution server 300.

The output control unit 255 may generate video information in which the first positional information of each player and the identification information of the player are associated with each other, by using the tracking information buffer 241, and output the generated video information to the display unit 230 for display on the display unit 230. Output of such video information by the output control unit 255 allows the administrator to support a task of inputting specific identification information.

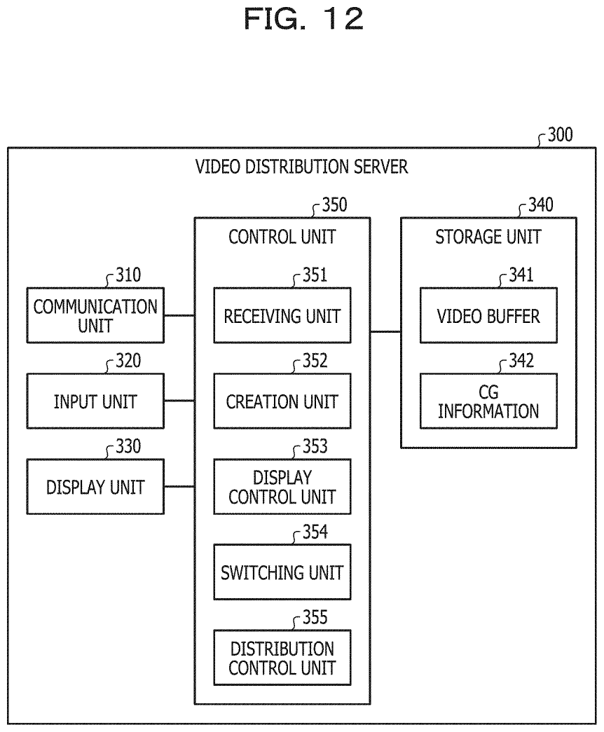

An example of a configuration of the video distribution server 300 illustrated in FIG. 1 will now be described. FIG. 12 is a functional block diagram illustrating a configuration of a video distribution server according to the first embodiment. As illustrated in FIG. 12, the video distribution server 300 includes the communication unit 310, an input unit 320, a display unit 330, a storage unit 340, and a control unit 350.

The communication unit 310 is a processing unit that performs information communication with the second server 200. The communication unit 310 corresponds to a communication device, such as an NIC. For example, the communication unit 310 receives third video information, under-goal video information, and score video information from the second server 200. The control unit 350 described later exchanges information with the second server 200 via the communication unit 310.

The input unit 320 is an input device that inputs various types of information to the video distribution server 300. The input unit 320 corresponds to a keyboard, a mouse, a touch panel, and the like. The administrator references third video information, under-goal video information, and the like displayed on the display unit 330 and operates the input unit 320 so as to switch the video information to be distributed to viewers. The administrator may reference third video information related to a crowded area, and select a specific player included in the third video information by operating the input unit 320.

The display unit 330 is a display device that displays information output from the control unit 350. The display unit 330 corresponds to a liquid crystal display, an organic EL display, a touch panel, or the like. For example, the display unit 330 displays third video information, under-goal video information, score video information, and the like.

The storage unit 340 includes a video buffer 341 and CG information 342. The storage unit 340 corresponds to a semiconductor memory element, such as a RAM or a flash memory, or a storage device, such as an HDD.

The video buffer 341 is a buffer that holds third video information, under-goal video information, and score video information.

The CG information 342 is information of computer graphics (CG) of a timer and scores. The CG information 342 is created by a creation unit 352 described later.

The control unit 350 includes a receiving unit 351, the creation unit 352, a display control unit 353, a switching unit 354, and a distribution control unit 355. The control unit 350 may be implemented as a CPU, an MPU, or the like. The control unit 350 may be implemented as a hard-wired logic circuit, such as an ASIC or an FPGA.

The receiving unit 351 is a processing unit that receives third video information, under-goal video information, and score video information from the second server 200. The receiving unit 351 stores the received third video information, under-goal video information, and score video information in the video buffer 341. The receiving unit 351 receives the positional information of each player in the third video information from the second server 200, and stores the received positional information in the video buffer 341.

Using the score video information stored in the video buffer 341, the creation unit 352 reads a numerical value displayed on the timer 7a and a numerical value displayed on the scoreboard 7b. Using the read numerical values, the creation unit 352 creates CG of a timer and scores. The creation unit 352 stores information on the created CG of a timer and scores (CG information 342) in the storage unit 340. The creation unit 352 performs the processing mentioned above repeatedly at each time point.

The display control unit 353 is a processing unit that outputs the third video information, under-goal video information, and score video information stored in the video buffer 341 to the display unit 330 and displays such information on the display unit 330. When outputting third video information related to a crowded area to the display unit 330 and displaying the third video information, the display control unit 353 causes a cursor for specifying a player included in the third video information to be superimposed to correspond to any player in the third video information, using the positional information of each player in the third video information related to the crowded area.

The switching unit 354 is a processing unit that acquires video information selected by the administrator who operates the input unit 320, from the video buffer 341, and outputs the acquired video information to the distribution control unit 355. For example, when third video information is selected by the administrator, the switching unit 354 outputs the third video information to the distribution control unit 355. When under-goal video information is selected by the administrator, the switching unit 354 outputs the under-goal video information to the distribution control unit 355.

When any player included in third video information is selected by the administrator who operates the input unit 320, for example, by cursor manipulation, the switching unit 354 identifies the identification information of the player. The switching unit 354 transmits the identified identification information of the player, as specific identification information, to the second server 200.

The distribution control unit 355 is a processing unit that distributes video information output from the switching unit 354, to the terminal devices of viewers. In distributing video information, the distribution control unit 355 may distribute video information in such a manner that the CG information 342 is superimposed on the video information. Although not described, the distribution control unit 355 may distribute predetermined background music (BGM), audio information by a commentator, caption information, and the like in a superimposed manner on video information.

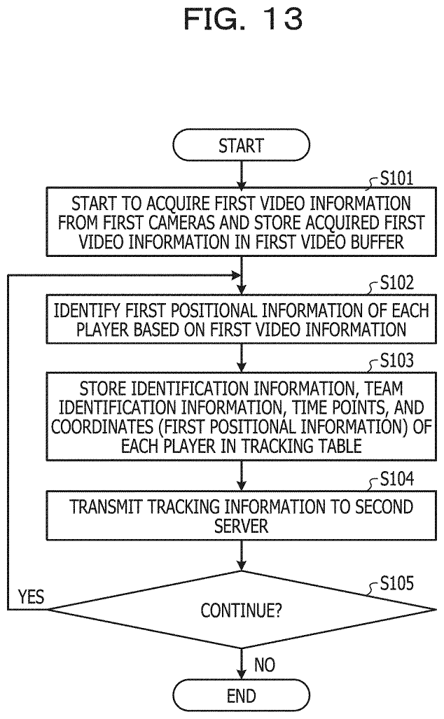

An example of the processing procedure of the first server 100 according to the first embodiment will now be described. FIG. 13 is a flowchart illustrating the processing procedure of a first server according to the first embodiment. As illustrated in FIG. 13, the acquisition unit 151 of the first server 100 starts to acquire first video information from the first cameras 4 and stores the acquired first video information in the first video buffer 141 (step S101).

The identification unit 152 of the first server 100 identifies the first positional information of each player based on the first video information (step S102). The identification unit 152 stores the identification information, team identification information, time points, and coordinates (first positional information) of each player in the tracking table 142 (step S103).

The transmitting unit 153 of the first server 100 transmits tracking information to the second server 200 (step S104). When the first server 100 continues the process (Yes in step S105), the process proceeds to step S102. However, when the first server 100 does not continue the process (No in step S105), the process terminates.

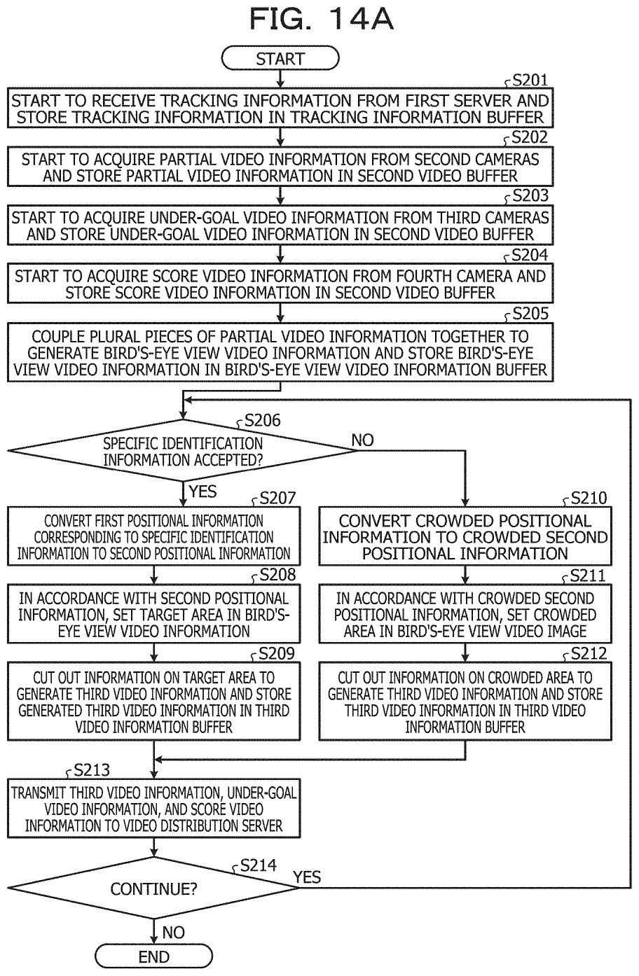

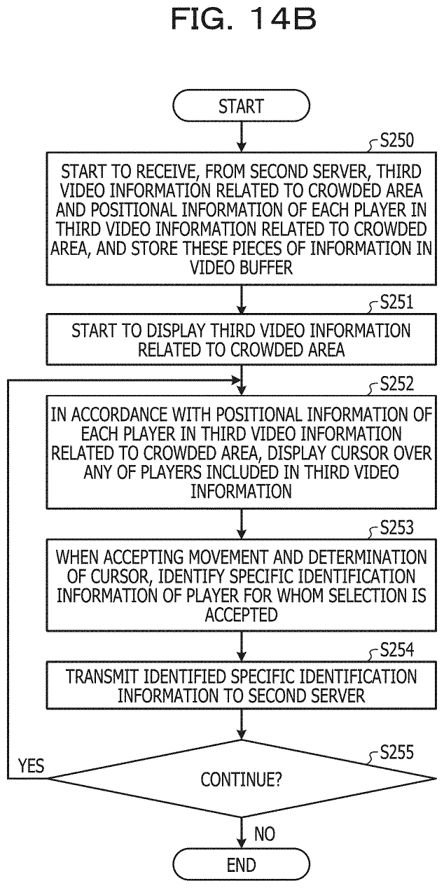

An example of the processing procedure of the second server 200 according to the first embodiment will now be described. FIG. 14A is a flowchart illustrating the processing procedure of a second server according to the first embodiment. As illustrated in FIG. 14A, the receiving unit 251 of the second server 200 starts to receive tracking information from the first server 100 and stores the received tracking information in the tracking information buffer 241 (step S201).

The acquisition unit 252 of the second server 200 starts to acquire partial video information from the second cameras 5 and stores the acquired partial video information in the second video buffer 242 (step S202). The acquisition unit 252 starts to acquire under-goal video information from the third cameras 6 and stores the acquired under-goal video information in the second video buffer 242 (step S203). The acquisition unit 252 starts to acquire score video information from the fourth camera 7 and stores the acquired score video information in the second video buffer 242 (step S204). The acquisition unit 252 couples plural pieces of partial video information together to generate bird's-eye view video information and stores the generated bird's-eye view video information in the bird's-eye view video information buffer 243 (step S205).

The conversion unit 253 of the second server 200 determines whether the identification information of a specific player (specific identification information) has been accepted (step S206). When the specific identification information has not been accepted (No in step S206), the conversion unit 253 converts the crowded positional information to crowded second positional information (step S210). In accordance with the crowded second positional information, the generation unit 254 sets a crowded area in the bird's-eye view video information (step S211). The generation unit 254 cuts out information on the crowded area to generate third video information (third image frame) and stores the generated third video information (third image frame) in the third video information buffer 245 (step S212), and the process proceeds step S213. For example, third video information for the crowded area is generated until the specific player is specified from the video distribution server 300. After a certain time period has elapsed since the specific player was specified from the video distribution server 300, third video information on the crowded area is generated.

However, when the specific identification information has been accepted (Yes in step S206), the conversion unit 253 converts first positional information corresponding to the specific identification information to second positional information (step S207).

The generation unit 254 of the second server 200 sets a target area in the bird's-eye view video information (bird's-eye view image frame) in accordance with the second positional information (step S208). The generation unit 254 generates third video information (third image frame) by cutting out information on the target area and stores the generated third video information (third image frame) in the third video information buffer 245 (step S209), and the process proceeds to step S213. If Yes is determined in step S206 until a predetermined time period has elapsed since the specific identification information was accepted, a close-up video image of a specific player (the third video information including the target area of the specific player) is generated.

The output control unit 255 of the second server 200 transmits the third video information, the under-goal video information, and the score video information to the video distribution server 300 (step S213). The output control unit 255 of the second server 200 transmits the positional information of each player in the third video information related to the crowded area, together with the above pieces of information, to the video distribution server 300. When the second server 200 continues the process (Yes in step S214), the process proceeds to step S206. However, when the second server 200 does not continue the process (No in step S214), the process terminates.

An example of the processing procedure of the video distribution server 300 in the case where specific identification information is specified on the side of the video distribution server 300 will now be described. FIG. 14B is a flowchart illustrating the processing procedure of a video distribution server according to the first embodiment. As illustrated in FIG. 14B, the receiving unit 351 of the video distribution server 300 starts to receive, from the second server 200, third video information related to a crowded area and the positional information of each player in the third video information related to the crowded area, and stores these pieces of information in the video buffer 341 (step S250). Although the example in which the video distribution server 300 accepts the third video information extracted from a bird's-eye view video image is described, the video distribution server 300 may accept a bird's-eye view video image or a low-resolution bird's-eye view video image obtained from the bird's-eye view video image.

The display control unit 353 of the video distribution server 300 starts to display third video information related to the crowded area (step S251). In accordance with the positional information of each player in the third video information related to the crowded area, the display control unit 353 displays a cursor such that the cursor is placed over any of players included in the third video information (step S252). In the initial state, the cursor is displayed, for example, such that the cursor is placed over a player wearing uniform number 4 of any team, or the like.

When the switching unit 354 of the video distribution server 300 accepts the movement and determination of a cursor (selection of a player), the switching unit 354 identifies the specific identification information of the player for whom the selection is accepted (step S253). The switching unit 354 transmits the identified specific identification information to the second server 200 by using the communication unit 310 (step S254). When the video distribution server 300 continues the process (Yes in step S255), the process proceeds to step S252. However, when the video distribution server 300 does not continue the process (No in step S255), the process terminates. Thereafter, in response to step S213 in the second server 200, the video distribution server 300 receives third video information related to a target area on a specific player for a certain time period. The video distribution server 300 distributes the video information selected by the administrator.

The effects of the video image generation system according to the first embodiment will now be described. In the video image generation system according to the first embodiment, the first server 100 sequentially identifies the first positional information of each of a plurality of players, based on the first video information captured by the first cameras 4, and transmits tracking information including the first positional information of each player to the second server 200. When the second server 200 accepts specific identification information, the second server 200 sequentially converts the first positional information of a player corresponding to the specific identification information to second positional information. The second server 200 generates third video information, which is a partial area cut out from the bird's-eye view video information in accordance with the second positional information obtained by sequential conversion, and outputs the generated third video information to the video distribution server 300. Thus, video information on the specific player may be automatically generated from video information on the entire area of the field where a plurality of players play a competition.

The second server 200 generates bird's-eye view video information from plural pieces of partial video information captured by the second cameras 5. This enables bird's-eye view video information including the entire area of the court 1 to be generated even when the shooting ranges of the second cameras 5 are fixed.

The second server 200 further corrects distortions in plural pieces of partial video information, and generates bird's-eye view video information from plural pieces of partial video information in which the distortions are corrected. This enables generation of bird's-eye view video information in which the effects of distortions are reduced.

In the first embodiment, plural pieces of partial video information are captured by a plurality of second cameras 5 and are coupled together, so that bird's-eye view video information is generated. However, the present disclosure is not limited to this. For example, in the case where the entire area of the court 1 is included in the shooting range of a single second camera, the acquisition unit 252 of the second server 200 may store partial video information captured by the single second camera (for example, the second camera 5b), as bird's-eye view video information, in the bird's-eye view video information buffer 243. In this case, the partial video information captured by the single second camera may correspond to second video information.

The conversion unit 253 of the second server 200 calculates the second positional information at each time point, and outputs the second positional information at each time point, as is, to the generation unit 254. However, the present disclosure is not limited to this. For example, the conversion unit 253 may calculate an average (moving mean) of the pieces of second positional information included for a predetermined time period and output the calculated average, as second positional information, to the generation unit 254.

Alternatively, the conversion unit 253 calculates a difference in the vertical direction between ytn and ytn+1 of the second positional information (xtn, ytn) at the time point Tn and the second positional information (xtn+1, ytn+1) at a time point Tn+1. If the difference is less than a threshold, the conversion unit 253 may output (xtn+1, ytn) as the second positional information at a time point Tn+1, to the generation unit 254. This enables the target area to be suppressed from vertically vibrating at each time point. Thus, third video information in which vertical vibrations are reduced may be generated.

In the first embodiment, a description has been given of the case where the second server 200 accepts specific identification information from an outside device or the input unit 220. However, the present disclosure is not limited to this. For example, the second server 200 may include a detection unit (not illustrated) that detects a predetermined event, and automatically detect, as specific identification information, the identification information of a player for whom the event has occurred.

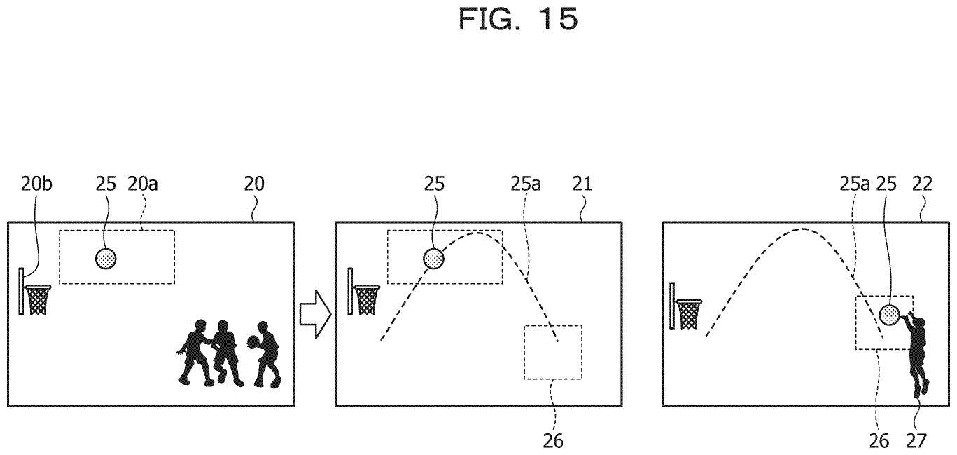

FIG. 15 is a diagram illustrating processing of the detection unit. Although not illustrated, the detection unit is to be coupled to the fifth camera. The fifth camera is to be a camera (stereo camera) that includes, in the imaging range, a periphery including a basketball hoop 20b.

In image frames captured by the fifth camera, a partial region 20a through which only a ball shot by a player would pass is set in advance. For example, the partial region 20a is set adjacent to the basketball hoop 20b.

The detection unit determines whether a ball is present in the partial region 20a. For example, the detection unit uses a template defining the shape and size of a ball to determine whether a ball is present in the partial region 20a. In the example illustrated in FIG. 15, the detection unit detects a ball 25 from the partial region 20a. When detecting the ball 25 in the partial region 20a, the detection unit calculates the three-dimensional coordinates of the ball 25 based on the principle of stereoscopy.

When detecting the ball 25 from the partial region 20a, the detection unit acquires an image frame 21, which precedes the image frame 20 by one or two frames, and detects the ball 25 from the image frame 21. The detection unit calculates the three-dimensional coordinates of the ball 25 detected from the image frame 21, based on the principle of stereoscopy.

Using, as a clue, the position of the ball 25 detected in the image frame 20, the detection unit may detect the ball 25 from the image frame 21. The detection unit estimates a path 25a of the ball 25 from the respective three-dimensional coordinates of the ball 25 detected from the image frames 20 and 21. Using the path 25a, the detection unit estimates a start position 26 of the path 25a and a time point at which the ball 25 is present at the start position 26. Hereafter, the time point at which the ball 25 is present at the start position 26 will be appropriately referred to as a “start time point”.

The detection unit acquires an image frame 22 corresponding to the start time point and detects the ball 25 from the start position 26. The detection unit calculates the three-dimensional coordinates of the ball 25 detected in the image frame 22, based on the principle of stereoscopy. The detection unit identifies a player 27 who is present at the three-dimensional coordinates of the ball 25. The detection unit detects the identification information of the player 27 in such a case, as specific identification information, and outputs the specific identification information to the conversion unit 253.

With reference to FIG. 15, by way of example, a description has been given of the case where an event “shooting” is detected and the identification information of a player who has shot is detected as specific identification information. However, the event is not limited to shooting but may be dribbling, passing, rebounding, assisting, or the like. The detection unit may use any related art technique to detect dribbling, passing, rebounding, assisting, or the like.

In the first embodiment, by way of example, the case where the first server 100 and the second server 200 are separate devices has been described. However, the present disclosure is not limited to this, and the first server 100 and the second server 200 may be the same device.

### Second Embodiment

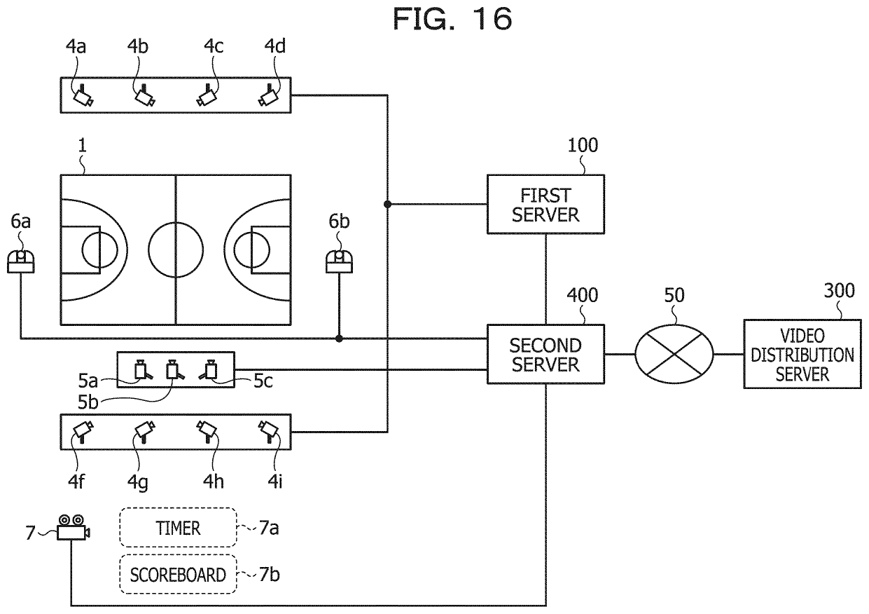

An example of a video image generation system according to a second embodiment will now be described. FIG. 16 illustrates an example of a video image generation system according to the second embodiment. As illustrated in FIG. 16, the video image generation system includes the first cameras 4, the second cameras 5, the third cameras 6, the fourth camera 7, and the fifth camera. The video image generation system includes the first server 100, a second server 400, and a video distribution server 500.

The description here of the first cameras 4, the second cameras 5, the third cameras 6, and the fourth camera 7 is similar to the description in the first embodiment of the first cameras 4, the second cameras 5, the third cameras 6, and the fourth camera 7.

The first server 100 is a device that acquires the first video information from the first cameras 4, and sequentially identifies the first positional information of each of a plurality of players based on the first video information. The first server 100 transmits tracking information in which the first positional information is associated with identification information uniquely identifying a player, to the second server 400. A description of the first server 100 is similar to the description of the first server 100 given in the first embodiment.

The second server 400 acquires tracking information from the first server 100 and acquires plural pieces of partial video information from the second cameras 5. The second server 400 generates bird's-eye view video information from the plural pieces of partial video information. When accepting specific identification information, using the tracking information, the second server 400 sequentially converts the first positional information of the player of the specific identification information to the second positional information in bird's-eye view video information. The second server 400 generates third video information, which is a partial area cut out from the bird's-eye view video information in accordance with the second positional information. The second server 400 transmits the generated third video information to the video distribution server 500.

The second server 400 calculates crowded positional information from the first positional information of each player and sequentially converts the crowded positional information to second crowded positional information. In accordance with the second crowded positional information, the second server 400 generates fourth video information that is a partial area cut out from the bird's-eye view video information. For example, the fourth video information is video images representing a plurality of players. The second server 400 transmits the generated fourth video information to the video distribution server 500. The fourth video information is an example of different video information.

The second server 400 may transmit bird's-eye view video information, instead of the fourth video information, to the video distribution server 500.

The video distribution server 500 is a device that receives third video information and fourth video information (or bird's-eye view video information) from the second server 400, selects either the received third video information or the received fourth video information, and distributes the selected video information to the terminal devices (not illustrated) of viewers.

In this way, in the video image generation system according to the second embodiment, an area in accordance with the second positional information is cut out from bird's-eye view video information, and an area in accordance with the second crowded positional information is also cut out. Thus, the third video information on a specific player and the fourth video information including a plurality of players may be automatically generated from the bird's-eye view video information of the entire area of the court 1 where a plurality of players play a competition.

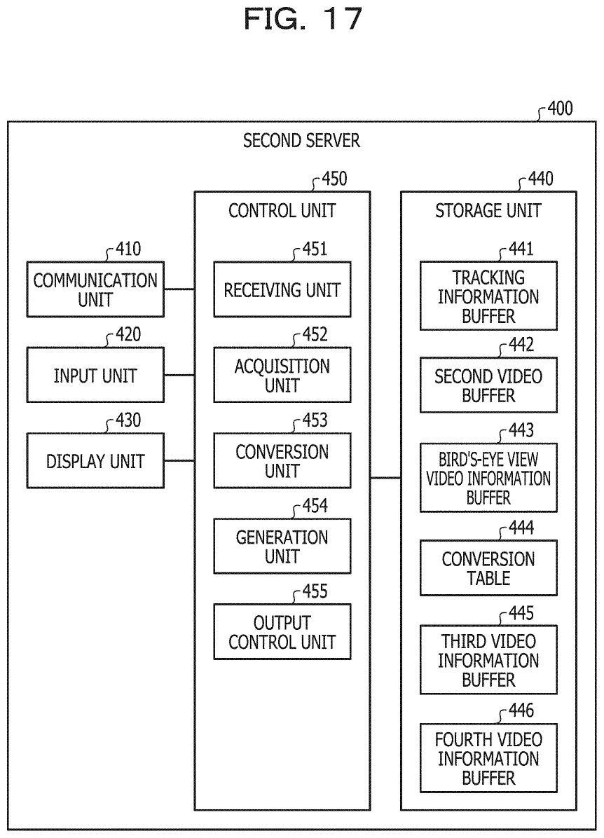

An example of a configuration of the second server 400 illustrated in FIG. 16 will now be described. FIG. 17 is a functional block diagram illustrating a configuration of a second server according to the second embodiment. As illustrated in FIG. 17, the second server 400 includes a communication unit 410, an input unit 420, a display unit 430, a storage unit 440, and a control unit 450.

The communication unit 410 is a processing unit that performs data communication with the second cameras 5, the third cameras 6, the fourth camera 7, the first server 100, and the video distribution server 500. The communication unit 410 corresponds to a communication device, such as an NIC. For example, the communication unit 410 receives partial video information from the second camera 5. The communication unit 410 receives under-goal video information from the third camera 6. The communication unit 410 receives score video information from the fourth camera 7. The communication unit 410 receives tracking information from the first server 100. The control unit 450 described later exchanges information with the second cameras 5, the third cameras 6, the fourth camera 7, the first server 100, and the video distribution server 500 via the communication unit 410.

The input unit 420 is an input device that inputs various types of information to the second server 400. The input unit 220 corresponds to a keyboard, a mouse, a touch panel, and the like. As described later, the administrator may operate the input unit 220 to input the identification information of a specific player.

The display unit 430 is a display device that displays information output from the control unit 450. The display unit 430 corresponds to a liquid crystal display, an organic EL display, a touch panel, or the like.

The storage unit 440 includes a tracking information buffer 441, a second video buffer 442, a bird's-eye view video information buffer 443, a conversion table 444, a third video information buffer 445, and a fourth video information buffer 446. The storage unit 440 corresponds to a semiconductor memory element, such as a RAM or a flash memory, or a storage device, such as an HDD.

The tracking information buffer 441 is a buffer that holds tracking information transmitted from the first server 100. The data structure of the tracking information buffer 441 is similar to the data structure of a tracking information buffer 241 depicted in FIG. 7.

The second video buffer 442 is a buffer that holds each of the partial video information captured by the second camera 5, the under-goal video information captured by the third camera 6, and the score video information captured by the fourth camera 7. The data structure of the second video buffer 442 is similar to the data structure of the second video buffer 242 depicted in FIG. 8A.

The bird's-eye view video information buffer 443 is a buffer that stores bird's-eye view video information. Other description regarding the bird's-eye view video information buffer 443 is similar to that regarding the bird's-eye view video information buffer 243 in the first embodiment.

The conversion table 444 is a table that defines the relationship between the first positional information and the second positional information. The first positional information corresponds to the coordinates of a player included in the tracking information transmitted from the first server 100. The second positional information corresponds to the coordinates in a bird's-eye view image frame (bird's-eye view video information).

The third video information buffer 445 is a buffer that stores third video information. The third video information includes third image frames arranged in the time sequence.

The fourth video information buffer 446 is a buffer that stores fourth video information. The fourth video information includes image frames arranged in the time sequence. An image frame included in the fourth video information is referred to as a “fourth image frame”. Each fourth image frame is provided with the time point information.

The control unit 450 includes a receiving unit 451, an acquisition unit 452, a conversion unit 453, a generation unit 454, and an output control unit 455. The control unit 450 may be implemented as a CPU, an MPU, or the like. The control unit 450 may be implemented as a hard-wired logic circuit, such as an ASIC or an FPGA.

The receiving unit 451 is a processing unit that sequentially receives tracking information from the first server 100. The receiving unit 451 sequentially stores the received tracking information in the tracking information buffer 441. As described above, the tracking information includes the identification information, team identification information, time points, and coordinates (first positional information) of each player.

The acquisition unit 452 is a processing unit that acquires partial video information from the second camera 5. The acquisition unit 452 stores the acquired partial video information in the second video buffer 442. The acquisition unit 452 stores the partial video information in the second video buffer 442 in such a manner that the partial video information is associated with the camera ID of the second camera 5.

The acquisition unit 452 acquires under-goal video information from the third camera 6. The acquisition unit 452 stores the acquired under-goal video information in the second video buffer 442 in such a manner that the under-goal video information is associated with the camera ID of the third camera 6.

The acquisition unit 452 acquires score video information from the fourth camera 7. The acquisition unit 452 stores the acquired score video information in the second video buffer 442 in such a manner that the score video information is associated with the camera ID of the fourth camera 7.

The acquisition unit 452 generates bird's-eye view video information from plural pieces of partial video information stored in the second video buffer 442. The processing in which the acquisition unit 452 generates bird's-eye view video information is similar to the processing of the acquisition unit 252 in the first embodiment. The acquisition unit 452 stores the bird's-eye view video information in the bird's-eye view video information buffer 443.

The conversion unit 453 is a processing unit that, when accepting identification information (specific identification information) of a specific player among a plurality of players, sequentially converts the first positional information of the specific player when and after the identification information is accepted, to the second positional information. The processing in which the conversion unit 453 converts first positional information to second positional information is similar to the processing of the conversion unit 253 in the first embodiment. After accepting the specific identification information, the conversion unit 453 sequentially converts the first positional information to the second positional information for a predetermined time period (from the time point T1 to the time point Tm) and time-sequentially outputs the second positional information to the generation unit 254.

The conversion unit 453 identifies second crowded positional information. The processing in which the conversion unit 453 identifies the second crowded positional information is similar to the processing in which the conversion unit 253 in the first embodiment identifies the second crowded positional information. The conversion unit 453 sequentially calculates the crowded second positional information and time-sequentially outputs the calculated crowded second positional information to the generation unit 254.

The generation unit 454 is a processing unit that generates third video information, which is a partial area cut out from the bird's-eye view video information in accordance with the second positional information obtained by the conversion sequentially performed by the conversion unit 453. The processing in which the generation unit 454 generates the third video information is similar to the processing of the generation unit 254 in the first embodiment. The generation unit 454 stores the third video information in the third video information buffer 445.

The generation unit 454 accepts crowded second positional information from the conversion unit 453. In accordance with the crowded second positional information, the generation unit 454 sets a partial area to be cut out (crowded area) in the bird's-eye view image frame. The generation unit 454 generates a fourth image frame by cutting out information on a crowded area from a bird's-eye view image frame.

The generation unit 454 generates fourth image frames by repeatedly performing the processing described above for a predetermined time period during which the generation unit 454 accepts the crowded second positional information from the conversion unit 453, and sequentially stores the fourth image frames in the fourth video information buffer 446.

The output control unit 455 is a processing unit that outputs the third video information stored in the third video information buffer 445 and the fourth video information stored in the fourth video information buffer 446, to the video distribution server 500. The output control unit 455 may output the under-goal video information and the score video information stored in the second video buffer 442, to the video distribution server 500.

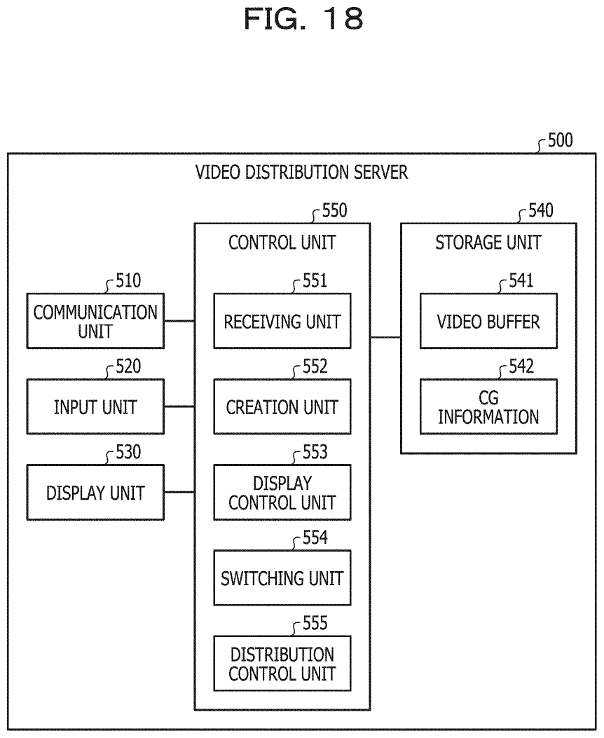

An example of a configuration of the video distribution server 500 illustrated in FIG. 16 will now be described. FIG. 18 is a functional block diagram illustrating a configuration of a video distribution server according to the second embodiment. As illustrated in FIG. 18, the video distribution server 500 includes a communication unit 510, an input unit 520, a display unit 530, a storage unit 540, and a control unit 550.

The communication unit 510 is a processing unit that performs information communication with the second server 400. The communication unit 510 corresponds to a communication device, such as an NIC. For example, the communication unit 510 receives third video information, fourth video information, under-goal video information, and score video information from the second server 400. The control unit 550 described later exchanges information with the second server 400 via the communication unit 510.

The input unit 520 is an input device that inputs various types of information to the video distribution server 500. The input unit 520 corresponds to a keyboard, a mouse, a touch panel, and the like. The administrator references third video information, fourth video information, under-goal video information, and the like displayed on the display unit 530 and operates the input unit 520 so as to switch video information to be distributed to viewers.

The display unit 530 is a display device that displays information output from the control unit 550. The display unit 530 corresponds to a liquid crystal display, an organic EL display, a touch panel, or the like. For example, the display unit 530 displays third video information, fourth video information, under-goal video information, score video information, and the like.

The storage unit 540 includes a video buffer 541 and CG information 542. The storage unit 540 corresponds to a semiconductor memory element, such as a RAM or a flash memory, or a storage device such as an HDD.

The video buffer 541 is a buffer that holds third video information, fourth video information, under-goal video information, and score video information.

The CG information 542 is information of CG of a timer and scores. The CG information 542 is created by a creation unit 552 described later.

The control unit 550 includes a receiving unit 551, the creation unit 552, a display control unit 553, a switching unit 554, and a distribution control unit 555. The control unit 550 may be implemented as a CPU, an MPU, or the like. The control unit 550 may be implemented as a hard-wired logic circuit, such as an ASIC or an FPGA.

The receiving unit 551 is a processing unit that receives third video information, fourth video information, under-goal video information, and score video information from the second server 400. The receiving unit 551 stores the received third video information, fourth video information, under-goal video information, and score video information in the video buffer 541. The receiving unit 551 receives the positional information of each player in the fourth video information related to a crowded area from the second server 200 and stores the received positional information in the video buffer 541.

Using the score video information stored in the video buffer 541, the creation unit 552 reads a numerical value displayed on the timer 7a and a numerical value displayed on the scoreboard 7b. Using the read numerical values, the creation unit 552 creates CG of a timer and scores. The creation unit 552 stores information on the created CG of a timer and scores (CG information 542) in the storage unit 540. The creation unit 552 performs the processing mentioned above repeatedly at each time point.

The display control unit 553 is a processing unit that outputs the third video information, fourth video information, under-goal video information, and score video information stored in the video buffer 541 to the display unit 530 and displays such information on the display unit 530. When outputting fourth video information related to a crowded area to the display unit 530 and displaying the fourth video information, the display control unit 553 causes a cursor for specifying a player included in the fourth video information to be superimposed to correspond to any player in the fourth video information, using the positional information of each player in the fourth video information related to the crowded area.

The switching unit 554 is a processing unit that acquires video information selected by the administrator who operates the input unit 520, from the video buffer 541, and outputs the acquired video information to the distribution control unit 555. For example, when third video information is selected by the administrator, the switching unit 554 outputs the third video information to the distribution control unit 555. When fourth video information is selected by the administrator, the switching unit 554 outputs the fourth video information to the distribution control unit 555. When under-goal video information is selected by the administrator, the switching unit 554 outputs the under-goal video information to the distribution control unit 555.

When any player included in fourth video information is selected by the administrator who operates the input unit 520, for example, by cursor manipulation, the switching unit 554 identifies the identification information of the player. The switching unit 554 transmits the identified identification information of the player, as specific identification information, to the second server 400.

The distribution control unit 555 is a processing unit that distributes video information output from the switching unit 554, to the terminal devices of viewers. In distributing video information, the distribution control unit 555 may distribute video information in such a manner that the CG information 542 is superimposed on the video information. Although not described, the distribution control unit 555 may distribute predetermined background music (BGM), audio information by a commentator, caption information, and the like in a superimposed manner on video information.

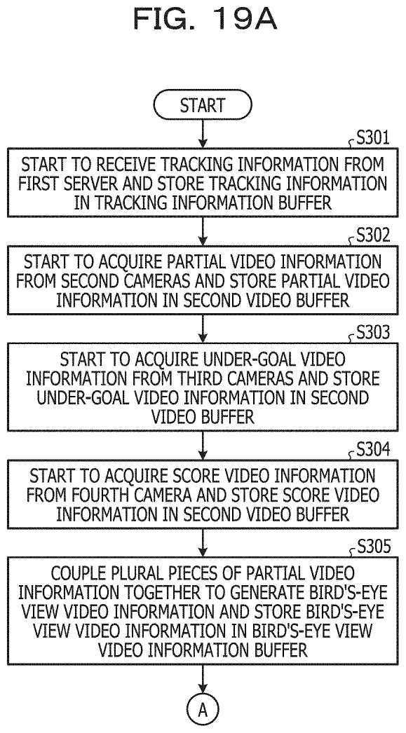

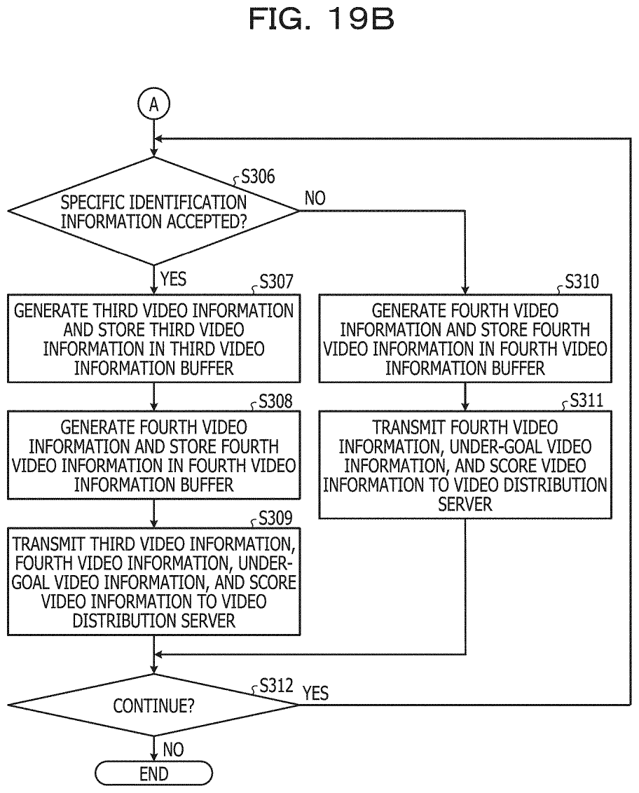

An example of the processing procedure of the second server 400 according to the second embodiment will now be described. FIG. 19A and FIG. 19B are a flowchart illustrating a processing procedure of a second server according to the second embodiment. As illustrated in FIG. 19A and FIG. 19B, the receiving unit 451 of the second server 400 starts to receive tracking information from the first server 100 and stores the received tracking information in the tracking information buffer 441 (step S301).

The acquisition unit 452 of the second server 400 starts to acquire partial video information from the second cameras 5 and stores the acquired partial video information in the second video buffer 442 (step S302). The acquisition unit 452 starts to acquire under-goal video information from the third cameras 6 and stores the acquired under-goal video information in the second video buffer 442 (step S303). The acquisition unit 452 starts to acquire score video information from the fourth camera 7 and stores the acquired score video information in the second video buffer 442 (step S304). The acquisition unit 452 couples plural pieces of partial video information together to generate bird's-eye view video information and stores the generated bird's-eye view video information in the bird's-eye view video information buffer 443 (step S305).

The second server 400 determines whether the second server 400 has accepted specific identification information (step S306). When the specific identification information has been accepted (Yes in step S306), the generation unit 454 generates third video information and stores the generated third video information in the third video information buffer 445 (step S307). The generation unit 454 generates fourth video information and stores the generated fourth video information in the fourth video information buffer 446 (step S308). The output control unit 455 of the second server 400 transmits the third video information, the fourth video information, the under-goal video information, and the score video information to the video distribution server 500 (step S309), and the process proceeds to step S312.

However, when the specific identification information has not been accepted (No in step S306), the generation unit 454 generates fourth video information and stores the generated fourth video information in the fourth video information buffer 446 (step S310). The output control unit 455 transmits the fourth video information, the under-goal video information, and the score video information to the video distribution server 500 (step S311), and the process proceeds to step S312. When the second server 400 continues the process (Yes in step S312) the process proceeds to step S306. However, when the second server 400 does not continue the process (No in step S312), the process terminates.

The effects of a video image generation system according to the second embodiment will now be described. In this way, in the video image generation system according to the second embodiment, an area in accordance with the second positional information is cut out from bird's-eye view video information, and an area in accordance with the second crowded positional information is also cut out from the bird's-eye view video information. Thus, the third video information on a specific player and the fourth video information including a plurality of players may be automatically generated from the bird's-eye view video information of the entire area of the court 1 where a plurality of players play a competition.

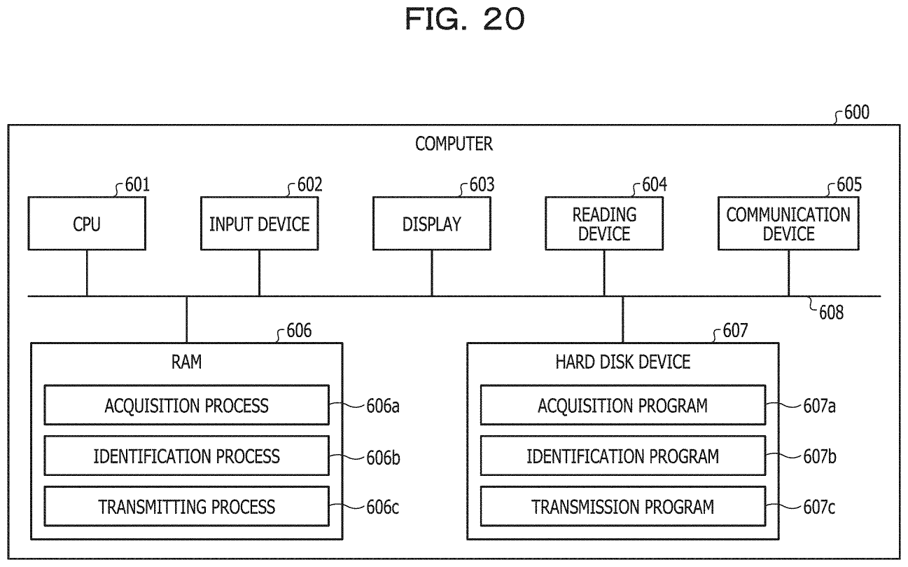

The following describes an example of the hardware configuration of a computer that achieves functions similar to those of the first server 100 described above in the embodiments. FIG. 20 illustrates an example of a hardware configuration of a computer that achieves functions similar to those of a first server.

As illustrated in FIG. 20, a computer 600 includes a CPU 601 that executes various types of arithmetic processing, an input device 602 that accepts input of data from a user, and a display 603. The computer 600 includes a reading device 604 that reads a program or the like from a storage medium, and a communication device 605 that exchanges data with the first cameras 4, the second server 200, or the like via a wired or wireless network. The computer 600 includes a RAM 606 that temporarily stores various types of information, and a hard disk device 607. Each of the devices 601 to 607 is coupled to a bus 608.

An acquisition program 607a, an identification program 607b, and a transmission program 607c are in the hard disk device 607. The CPU 601 reads the programs 607a to 607c into the RAM 606.

The acquisition program 607a functions as an acquisition process 606a. The identification program 607b functions as an identification process 606b. The transmission program 607c functions as a transmitting process 606c.

The processing of the acquisition process 606a corresponds to the processing of the acquisition unit 151. The processing of the identification process 606b corresponds to the processing of the identification unit 152. The processing of the transmitting process 606c corresponds to the processing of the transmitting unit 153.

The programs 607a to 607c may not be stored in the hard disk device 607 from the beginning. For example, the programs may be stored in a “portable physical medium” to be inserted into the computer 600, such as a floppy disk (FD), a compact disk read-only memory (CD-ROM), a digital versatile disk (DVD), a magneto-optical disk, or an integrated circuit (IC) card. The computer 600 may read and execute the programs 607a to 607c.

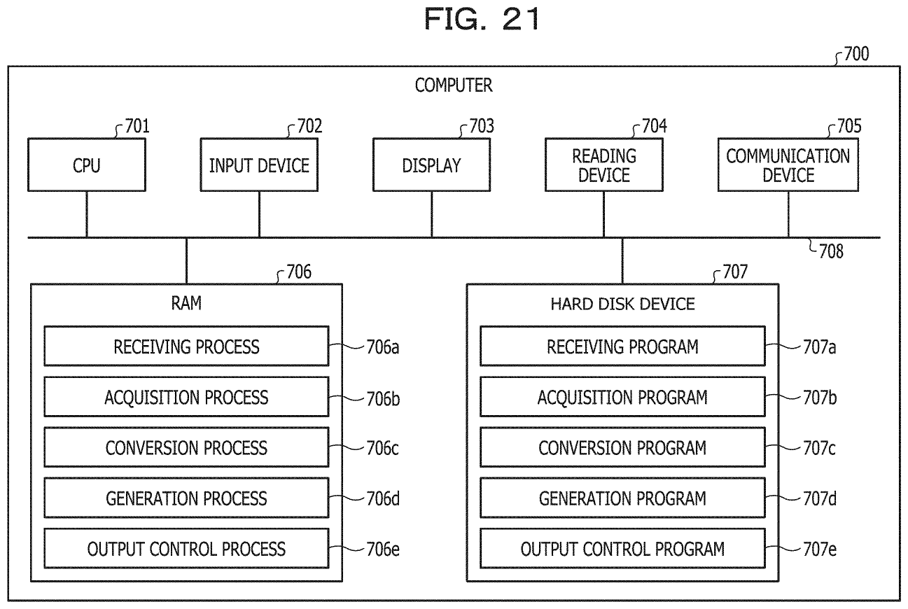

The following describes an example of the hardware configuration of a computer that achieves functions similar to those of the second server 200 (400) described above in the embodiments. FIG. 21 illustrates an example of a hardware configuration of a computer that achieves functions similar to those of a second server.

As illustrated in FIG. 21, a computer 700 includes a CPU 701 that executes various types of arithmetic processing, an input device 702 that accepts input of data from a user, and a display 703. The computer 700 includes a reading device 704 that reads a program or the like from a storage medium, and a communication device 705 that exchanges data with the second cameras 5, the third cameras 6, the fourth camera 7, the first server 100, the video distribution server 300, or the like via a wired or wireless network. The computer 700 includes a RAM 706 that temporarily stores various types of information, and a hard disk device 707. Each of the devices 701 to 707 is coupled to a bus 708.

A receiving program 707a, an acquisition program 707b, a conversion program 707c, a generation program 707d, and an output control program 707e are in the hard disk device 707. The CPU 701 reads the programs 707a to 707e into the RAM 706.

The receiving program 707a functions as a receiving process 706a. The acquisition program 707b functions as an acquisition process 706b. The conversion program 707c functions as a conversion process 706c. The generation program 707d functions as a generation process 706d. The output control program 707e functions as an output control process 706e.

The processing of the receiving process 706a corresponds to the processing of the receiving unit 251. The processing of the acquisition process 706b corresponds to the processing of the acquisition unit 252. The processing of the conversion process 706c corresponds to the processing of the conversion unit 253. The processing of the generation process 706d corresponds to the processing of the generation unit 254. The processing of the output control process 706e corresponds to the processing of the output control unit 255.

The programs 707a to 707e may not be stored in the hard disk device 707 from the beginning. For example, the programs may be stored in a “portable physical medium” to be inserted into the computer 700, such as an FD, a CD-ROM, a DVD, a magneto-optical disk, or an IC card. The computer 700 may read and execute the programs 707a to 707e.

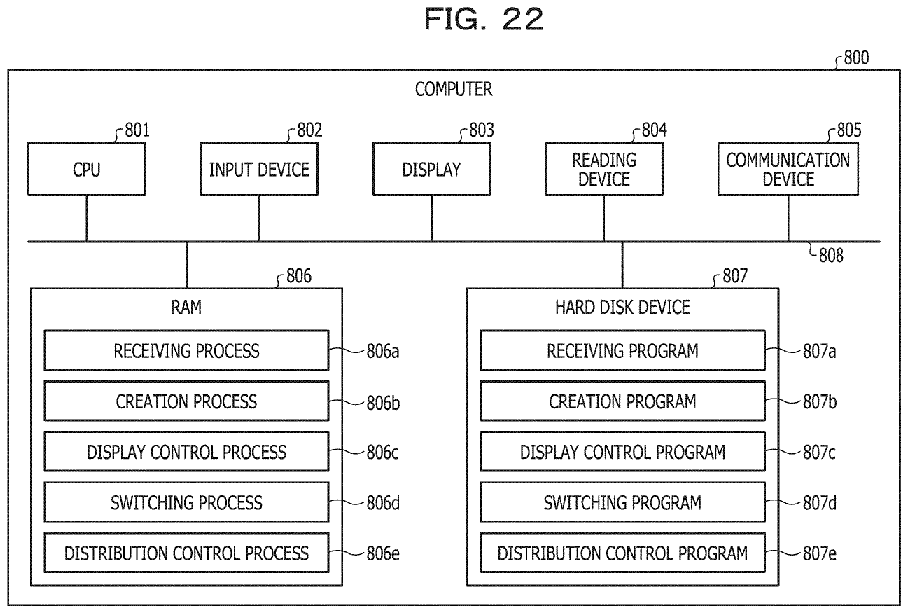

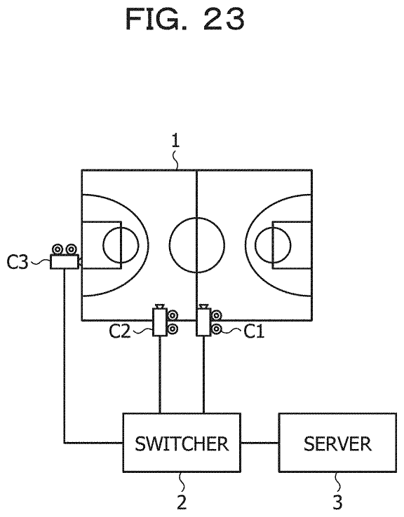

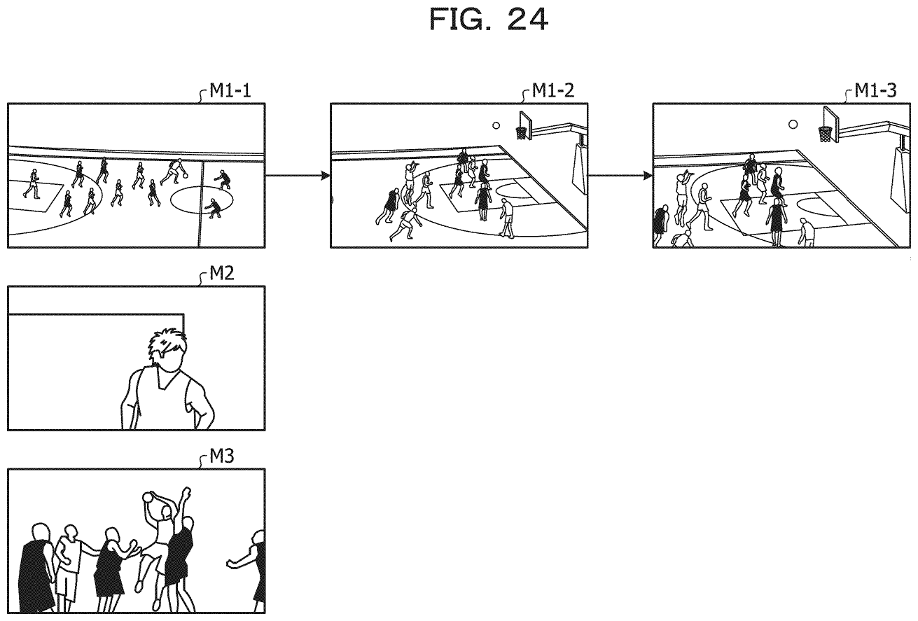

The following describes an example of the hardware configuration of a computer that achieves functions similar to those of the video distribution server 300 (500) described above in the embodiments. FIG. 22 illustrates an example of a hardware configuration of a computer that achieves the functions similar to those of a video distribution server.

As illustrated in FIG. 22, a computer 800 includes a CPU 801 that executes various types of arithmetic processing, an input device 802 that accepts input of data from a user, and a display 803. The computer 800 includes a reading device 804 that reads a program or the like from a storage medium, and a communication device 805 that exchanges data with the second server 200 or the like via a wired or wireless network. The computer 800 includes a RAM 806 that temporarily stores various types of information, and a hard disk device 807. Each of the devices 801 to 807 is coupled to a bus 808.

A receiving program 807a, a creation program 807b, a display control program 807c, a switching program 807d, and a distribution control program 807e are in the hard disk device 807. The CPU 801 reads the programs 807a to 807e into the RAM 806.

The receiving program 807a functions as a receiving process 806a. The creation program 807b functions as a creation process 806b. The display control program 807c functions as a display control process 806c. The switching program 807d functions as a switching process 806d. The distribution control program 807e functions as a distribution control process 807e.

The processing of the receiving process 806a corresponds to the processing of the receiving unit 351. The processing of the creation process 806b corresponds to the processing of the creation unit 352. The processing of the display control process 806c corresponds to the processing of the display control unit 353. The processing of the switching process 806d corresponds to the processing of the switching unit 354. The processing of the distribution control process 806e corresponds to the processing of the distribution control unit 355.

The programs 807a to 807e may not be stored in the hard disk device 807 from the beginning. For example, the programs may be stored in a “portable physical medium” to be inserted into the computer 800, such as an FD, a CD-ROM, a DVD, a magneto-optical disk, or an IC card. The computer 800 may read and execute the programs 807a to 807e.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes a computer to execute a process, the process comprising:
receiving first positional information of each of a plurality of players, the first positional information being identified based on first video information captured by a plurality of first cameras installed in a field where the plurality of players play a competition;
acquiring second video information from a second camera that captures a video image of the competition;
when accepting identification information of a specific player among the plurality of players, converting first positional information of the specific player when and after the identification information is accepted, to second positional information in the second video information;
generating third video information that is a partial area cut out from the second video information based on the second positional information obtained by the conversion; and
outputting the third video information.

2. The non-transitory computer-readable storage medium storing a program according to claim 1, wherein
the third video information is a close-up video image of the specific player.

3. The non-transitory computer-readable storage medium storing a program according to claim 1, wherein
the second camera is a camera with a higher resolution than the first camera, and
the third video information cut out from the second video information of the second camera is information to be distributed to a terminal of a viewer of the competition.

4. The non-transitory computer-readable storage medium storing a program according to claim 1, wherein
the acquiring second video information includes:
acquiring plural pieces of partial video information from a plurality of second cameras that capture video images of respective areas of the field, and
generating the second video information from the plural pieces of partial video information.

5. The non-transitory computer-readable storage medium storing a program according to claim 4, wherein
the acquiring second video information further includes:
correcting distortions of the plural pieces of partial video information, and
generating the second video information from plural pieces of partial video information in which distortions are corrected.

6. The non-transitory computer-readable storage medium storing a program according to claim 1, wherein
the specific player is a player related to an event that occurs in the competition.

7. The non-transitory computer-readable storage medium storing a program according to claim 1,
wherein the converting includes calculating, every predetermined time period, average positional information by averaging plural pieces of second positional information included in a predetermined time period,
wherein the generating includes generating different video information that is a partial area cut out from the second video information, in accordance with the average positional information.

8. The non-transitory computer-readable storage medium storing a program according to claim 1, wherein
the first positional information is information indicating a three-dimensional position of each of the plurality of players in the field, and
the second positional information is information indicating a two-dimensional position of each of the plurality of players in the second video information.

9. A video image generation method executed by a computer, the video image generation method comprising:
receiving first positional information of each of a plurality of players, the first positional information being identified based on first video information captured by a plurality of first cameras installed in a field where the plurality of players play a competition;
acquiring second video information from a second camera that captures a video image of the competition;
when accepting identification information of a specific player among the plurality of players, converting first positional information of the specific player when and after the identification information is accepted, to second positional information in the second video information;
generating third video information that is a partial area cut out from the second video information based on the second positional information obtained by the conversion; and
outputting the third video information.

10. A video image generation system comprising:
a first server that includes a first memory and a first processor coupled to the first memory; and
a second server that includes a second memory and a second processor coupled to the second memory,
wherein the first processor is configured to:
acquire first video information from a plurality of first cameras installed in a field where a plurality of players play a competition,
identify first positional information of each of the plurality of players, based on the first video information, and
transmit first positional information of each of the plurality of players to the second server,
wherein the second processor is configured to:
receive first positional information of each of the plurality of players from the first server,
acquire second video information from a second camera that captures a video image of the competition;
when accepting identification information of a specific player among the plurality of players, convert first positional information of the specific player when and after the identification information is accepted, to second positional information in the second video information;
generate third video information that is a partial area cut out from the second video information based on the second positional information obtained by the conversion; and
output the third video information.

11. The video image generation system according to claim 10, wherein
the third video information is a close-up video image of the specific player.

12. The video image generation system according to claim 10, wherein
the second camera is a camera with a higher resolution than the first camera, and
the third video information cut out from the second video information of the second camera is information to be distributed to a terminal of a viewer of the competition.

13. The video image generation system according to claim 10,
wherein the second processor is configured to acquire plural pieces of partial video information from a plurality of second cameras that capture video images of respective areas of the field,
wherein the second processor is configured to generate the second video information from the plural pieces of partial video information.

14. The video image generation system according to claim 13, wherein the second processor is further configured to:
correct distortions of the plural pieces of partial video information, and
generate the second video information from plural pieces of partial video information in which distortions are corrected.
